(19) United States
(12) Patent Application Publication
(10) Pub. No.: US 2012/0255240 A1
(43) Pub. Date: Oct. 11, 2012

(54) PREFABRICATED CONTAINER HOUSE

(76) Inventor: Kangna Nelson SHEN, Tokyo (JP)

(21) Appl. No.: 13/424,473

(22) Filed: Mar. 20, 2012

Related U.S. Application Data
(63) Continuation-in-part of application No. 12/385,516, filed on Apr. 9, 2009, now Pat. No. 8,141,304.
Application No. 12/385,516 is a continuation of application No. PCT/US2010/042700, filed on Jul. 21, 2010.
Application No. PCT/US2010/042700 is a continuation of application No. PCT/US2009/005859, filed on Oct. 29, 2009.

(30) Foreign Application Priority Data
Feb. 5, 2009 (JP) 2009-025413

(51) Int. Cl. E04B 1/343; E04B 1/00; E02D 35/00; B65G 65/00; E04B 1/92; E02D 27/50; E04H 1/04; E04F 11/00; E04H 9/02; E04F 11/02

(52) U.S. Cl. 52/79.5; 52/167.1; 52/169.1; 52/125.3; 52/185; 52/741.3; 52/741.15; 52/745.13; 52/741.2; 414/809

(57) ABSTRACT

A transportable prefabricated container house includes a main body and a house forming body, configured to be housed in the main body and drawn out of the main body at the installation site to be expanded/assembled into a house threefold the size of the main body. Assembly of the pre-assembled square “U”-shape walls sandwiched between the floor and ceiling boards includes tightly tying the ceiling supporting beams and the floor supporting beams together with shackles, and passing steel rods or pipes between the walls to render the house immune from earthquakes and hurricanes. A foundation of steel pipe bodies assists earthquake- and hurricane-resistance. Mega structures housing multitudes of container houses can be used when stacking two or more container houses is insufficient and large scale urban development is necessary, and are capable of resisting earthquakes and hurricanes due to a system of wire mesh covering.

### CROSS REFERENCE

This application is a Continuation In Part of U.S. patent application Ser. No. 12/385,516 filed on Apr. 9, 2009, which claims priority to Japanese Application No. 2009-025413 filed on Feb. 5, 2009; and is a Continuation of International Application PCT/US2010/042700 filed on Jul. 21, 2010, which claims priority to International Application PCT/US2009/005859 filed on Oct. 29, 2009. The entire content of each of which is hereby incorporated by reference in its entirely.

### DESCRIPTION

1. Technical Field

The present invention relates to a prefabricated container house which can be put on a chassis or trailer and pulled by truck or tractor to its installation site.

The house can also be lifted on and lifted off a container ship, railcar and tractor-trailer with the use of appropriate equipment such as a crane or forklift.

2. Background Art

A prefabricated house for a provisional house or dwelling is proposed in Japanese Patent Application Publication No. 2005-155012 as an assemblable dwelling. Such a prefabricated house is built with housing frame members such as floor members and roof members, and partitioning members such as wall members. The prefabricated house is transported to a construction site, i.e. the installation site. These members are then assembled on a foundation prepared at the construction site in advance by specialized workers, for example, carpenters and bricklayers.

It takes time to disassemble such a prefabricated house, and once built, the prefabricated house is not easy to remove from the construction site.

Likewise, a trailer house used as a dwelling that can be moved to any installation site is proposed in Japanese Utility Model Registration No. 3127532. Such a trailer house comes pre-assembled with a predetermined room arrangement, and is pulled and moved to an installation site, using a trailer truck. At the destination, the trailer house is used as a dwelling.

This kind of prefabricated house is, however, inconvenient because the prefabricated house is fastened at the construction site and cannot be moved. Furthermore, in order to extend the dwelling, several members need to be assembled and added to the existing member or members which have already been assembled. Extension work is, therefore, cumbersome.

In the meantime, a trailer house is movable and does not need to be assembled at its destination. However, since a trailer house has already been assembled into a house, the trailer house is limited in its size when it comes to mobility, which makes the trailer house impossible to function as a spacious house. Also since a trailer house cannot be extended, it would be an inconvenient living space.

### CITATION LIST

### Patent Literature

### [PTL 1]

Japanese Patent Application Publication No. 2005-155012

### [PTL 2]

Japanese Utility Model Registration No. 3127532

### SUMMARY OF INVENTION

The objectives of the present invention include:

(1) to provide a prefabricated container house which can be moved to any place, which enables the amount of cumbersome assembly work to be reduced to a minimum and which enables living space to be extended nearly threefold based on a single unit in two separate ways. In a particular embodiment, the house is designed with pre-assembled square “U”-shaped walls sandwiched between the ceiling and the floor boards. This design is highly earthquake- and hurricane-resistant when combined with a system of cables and shackles for tying together and tightening the ceiling rods or beams and the floor rods or beams; and, further by perpendicularly holding the said walls together with steel rods;

(2) to provide a foundation for such a house which would render the house further immune to the ravages of earthquake and hurricane; and

(3) to provide an earthquake- and hurricane-resistant mega structure, which would enable hundreds and thousands of these houses to be situated in a single location.

A first aspect of the invention is to provide a prefabricated container house comprising: a main body transportable/movable to an installation site and a house forming body configured to be housed in the main body, transported/moved to the installation site along with the main body and drawn out of the main body at the installation site to be expanded and assembled.

The main body includes a container-shaped main frame member capable of being pulled by a trailer truck when placed on a chassis. The house forming body includes a plurality of dwelling forming members which are housed in the main frame member and which are drawn out of the main frame member at the installation site and assembled into a house. The main frame member may be formed into a box shape with a pair of upper and lower horizontal frames forming a floor and a ceiling, respectively, and with a pair of vertical frames each connecting the horizontal frames at the ends of the horizontal frames to form a wall. Or, a square “U”-shaped pre-assembled wall unit may be formed and recessed in the main frame member. This “U”-shaped wall unit needs only to be pulled out and sandwiched between the floor and the ceiling. The dwelling forming members may include a floor board, a ceiling board, wall panels, a bath/toilet unit, and a kitchen unit. The main frame member may house a sub-frame member including: a floor supporting frame (beam) supporting the floor board which is drawn out of the main frame member and assembled at the installation site, and a ceiling supporting frame (beam) supporting the ceiling board which is drawn out of the main frame member and assembled at the installation site.

The sub-frame member may include a plurality of reinforcing columns provided between the pair of horizontal frames so as to reinforce the main frame member.

The floor supporting frame (beam) and the ceiling supporting frame (beam) may be drawn outward from the horizontal main frames.

Two or more of the house bodies may be stacked to form a multi-story dwelling.

The floorboard and the ceiling board are overlapped and housed between the pair of horizontal frames and some of the wall panels may be overlapped with the corresponding one of the vertical frames and housed, and the rest of the wall panels may be overlapped and housed at an intermediate position between the vertical frames. Or, the wall panels may be pre-assembled in a square “U”-shape and be housed at an intermediate position between the vertical frames, needing the walls to be only pulled out of the main horizontal frame and sandwiched between the floor and the ceiling.

The prefabricated container house is also comprised of a foundation body to be installed at the installation site for the prefabricated container house to be mounted on it.

The installation foundation body includes a buried pipe body buried in the ground with a pole body supported with two sets of dampers, one perpendicular to the pole body and the other at the bottom of the pole body in an approximately 45 degree angle holding the pole body upright in the buried pipe body in a state where a tip portion of the pole body protrudes from the ground. At the tail or opposite end of this pipe body a steel rim is welded to the pipe body and a lid is attached to the steel rim with a hinge; or the lid may be welded on directly to the pipe body.

The pole body in the buried pipe body is supported in the pole body by the dampers. The buried pipe body includes a peripheral wall part having a hollow inside, a steel ring welded to the pipe body at the lower end, and a lid attached with a hinge at the lower end of the peripheral wall part allowing the cover to open and close at the lower end; or the lid at the lower end is welded to the pipe body. An upper stationary cover body is provided with a rubberized O-ring between the inside of the cover body and the upper end of the peripheral wall part of the pipe body. An O-ring is also provided between the cover body and the pole body. An alternative embodiment of the foundation includes a pipe body with the pole body supported by the dampers and the O-ring between the inside of the cover body and the pole body, but having the lid welded to the pipe body and the cover body being welded to the pole body.

The pole body includes a rod-shaped pole main body having a mounting surface formed at the tip portion of the rod-shaped pole main body for the prefabricated container house to be mounted on. The pole body also includes two sets of dampers, one set perpendicular to the pole body and the other set at the bottom of the pole body in an approximately 45 degree angle, supporting the pole main body inside the buried pipe body.

The dampers include a ring-shaped connection part fixed to a periphery of the pole main body with one end of the dampers fixed or welded to the connection part, with the other ends of the dampers supported by the inner wall of the peripheral wall part.

The pipe body is placed into the ground where a hole has been bored for the pipe body. If necessary, the side of the hole can be sprayed with liquid cement to prevent the side of the hole from caving in before the pipe body has been inserted.

The main frame member may be formed into a box shape with a pair of upper and lower horizontal frames forming a floor and a ceiling, and with a pair of vertical frames each connecting the horizontal frames at ends of the horizontal frames to form a wall. Alternatively, the walls may be pre-assembled into a square “U”-shape which requires the walls to be only pulled out of the horizontal frames and sandwiched between the floor and ceiling.

The dwelling forming members include: a floorboard, a ceiling board, a wall panel, a bath/toilet unit, and a kitchen unit.

The wall panels include a unit wall having a first wall panel, a second wall panel and a third wall panel previously formed, i.e. pre-assembled, into a square “U”-shape in a planar view.

The main frame member may include one or more supporting frames or beams which are drawn out of the top and bottom of the main frame member at the installation site to support the floor and ceiling boards.

The floor board may be rotatably supported on the lower horizontal frame of the main frame member and is expanded onto the supporting frame or beam at the time of assembly.

The ceiling board may be rotatably supported on the upper horizontal frame of the main frame member and is expanded onto the support frame or beam at the time of assembly.

The prefabricated container houses may be built or assembled into a structure at the installation site and may be stacked three or more stories high. If in fact many, many container houses need to be situated in a single space, the mega structure is employed for this purpose. The mega structure is a steel structure designed to be earthquake- and hurricane-resistant for housing many, many prefabricated container houses. A staircase structure or stairwell with stairs and elevators is attached to the mega structure to allow movement between floors of the mega structure. The mega structure includes a plurality of pillar members provided upright from the ground, beam members connecting the pillar members and assembled into a grid-like structure together with the pillar members to define spaces for housing the prefabricated container houses with the pillar members. The mega structure also includes floors on which the prefabricated container houses placed are mounted. Container mounting parts, for example, twist-lock arrangements, are set into the floor. The floorboards are supported by the beam members.

The beam members may include framework beam members forming a framework together with the pillar members, and container supporting beam members connected between the framework beam members and supporting the floors. Each of the floors may include a container mounting part, for example, twist-lock arrangements, on which the prefabricated container house is mounted, and a corridor forming part adjacent to the container mounting part.

The staircase structure or stairwell may include pillar members, beam members, and stairs and/or elevator units provided in spaces defined by the pillar members and the beam members.

The mega structure may have a protection net on an outer peripheral portion of the structure, the protection net covering the sides of the structure. The protection net is attached to dampers which are attached to the pillar and beam members of the mega structure to help the mega structure resist earthquake and hurricane.

The protection net is itself attached to a separate framework built within the framework with the floors and staircase structures described above.

The mega structure is constructed of two identical structures facing each other horizontally. For assembling the mega structure, a crane is placed at the top straddling the two identical pair of mega structures. The crane will travel back and forth on tracks laid along the structures and hoist or lower prefabricated containers houses off or on a tractor-trailer on the ground level. Forklifts will receive the prefabricated container house from the crane and carry container houses to the place on the floor where the house is to be mounted.

By building and attaching several mega structures identical to each other and facing each other horizontally and by connecting the identical set of mega structures with tracks, a single crane is able to travel from one set of mega structure to another. Identical sets of mega structures can be built and connected in juxtaposition ad infinitum making the mega structure an ideal use for the prefabricated container house in an urban setting where limited space is available for housing.

A second aspect of the invention is to provide a container house comprising: a main frame member having a box shape, including a pair of vertical frames having a rectangular plate shape, upper and lower horizontal frames each having a rectangular plate shape connected to the pair of vertical frames, and an opening on at least one of side of the main frame member; a movable floorboard configured to horizontally extend from a lower portion of the main frame member outward of the main frame member; and, a movable ceiling board configured to horizontally extend from an upper portion of the main frame member outward of the main frame member.

Movable wall panels are provided so as to be drawn out of one of the vertical frames between the movable floorboard and the movable ceiling board, with the movable floorboard and the movable ceiling board extended horizontally.

The movable floorboard are supported on the lower portion of the main frame member pivotally between a vertical position and a horizontal position in a horizontal axis, and the movable floorboard may function as a cover closing the opening of the main frame member in the horizontal position.

The movable ceiling board are supported on the upper portion of the main frame member pivotally in a horizontal axis.

The movable wall panels include outer wall panels each supported at the end of the movable wall panels pivotally in a vertical axis.

The container house is further comprised of a floor supporting frame protrudable under the movable floorboard from a lower portion of the main frame member so as to support the movable floorboard extended horizontally.

The container house is also comprised of a ceiling supporting frame protrudable over the movable ceiling board from an upper portion of the main frame member so as to support the movable ceiling board extended horizontally.

The container house is comprised of a bed unit supported on a lower portion of the main frame member pivotally in a horizontal axis.

The movable wall panels pre-assembled in a square “U”-shape may be provided slidably on the movable floorboard to be sandwiched between the floor board and the ceiling board.

The movable ceiling board is supported on the upper portion of the main frame member pivotally between a vertical position and a horizontal position on a horizontal axis, and the movable ceiling board may function as a cover closing the opening of the main frame member in the horizontal position. A third aspect of the invention is to provide a container house, comprising: a main frame member having a box shape, including a pair of vertical frames having a rectangular plate shape, upper and lower horizontal frames each having a rectangular plate shape connected to the pair of vertical frames, and an opening on at least one of the sides of the main frame member.

A movable floor board is configured to horizontally extend from a lower portion of the main frame member outward of the main frame member, the movable floor board being supported on the lower portion of the main frame member pivotally between a vertical position and a horizontal position on a horizontal axis, and the movable floor board functioning as a cover closing the opening of the main frame member in the horizontal position; a movable ceiling board is configured to horizontally extend from an upper portion of the main frame member outward of the main frame member, the movable ceiling board being supported on the upper portion of the main frame member pivotally on a horizontal axis; movable pre-assembled square “U”-shape wall panels are provided so as to be drawn out of one of the vertical frames between the movable floor board and the movable ceiling board, with the movable floor board and the movable ceiling board extended horizontally, the movable pre-assembled square “U”-shape wall panels being provided slidably on the movable floor board to be sandwiched between the floor board and the ceiling board; the movable wall panels including outer wall panels each supported on an end of the movable wall panels pivotally on a vertical axis; a floor supporting frame or beam is protrudable under the movable floor board from the lower portion of the main frame member so as to support the movable floor board extended horizontally; and a ceiling supporting frame or beam protrudable over the movable ceiling board from the upper portion of the main frame member so as to support the movable ceiling board extended horizontally.

### ADVANTAGEOUS EFFECTS OF INVENTION

According to the above aspects and configurations, the prefabricated container house can be moved to any place. Specifically, the main body is transported or moved to an installation site on a chassis by a tractor or truck. The house can be lifted on and lifted off a container ship with the use of appropriate equipment such as a crane or forklift. The house forming body housed in the main body is drawn, expanded, and assembled to form a house or place of business such as office, shop, health clinic, or hotel room.

The only thing to do at the installation site is to draw the house forming body from the main body, expand and assemble the house forming body, and cumbersome assembly work is reduced to a minimum at the destination. In fact it is estimated that three persons can complete the work of expanding and assembling the house from its original main frame to the fully assembled house in about three hours for the house with the design of the walls pre-assembled into a square “U”-shape.

In the mega structure, the house main bodies can be stacked, so that space can be extended. And where there is need for many, many container houses to be situated in a single location, the mega structure will serve to satisfy this need ad infinitum through the use of the stacked house main bodies.

If there is ever a need for the houses to be relocated, this need can be met easily by taking the houses off the mounting foundations by crane or forklift and by placing them on a tractor trailer or flat rack. The prefabricated houses can then be taken to another location for re-use.

After the prefabricated house has been taken away, the foundations can be pulled out, first the pole body and then the pipe body, and there will be no debris that can be considered as harmful or not ecological left behind in the soil.

And if there is a need for one or many or all of the houses placed in the mega structure to be moved, this need too can be met with relative ease by using the crane which will lower the houses to the waiting chassis or trailers on the ground.

### BRIEF DESCRIPTION OF DRAWINGS

FIG. 1 is a perspective view of a movable prefabricated container house according to example 1 of the present invention, the movable container house being in an expanded state. Wires/cables connecting the ceiling and floor beams tied with shackles are displayed.

FIG. 2 is a perspective view of the movable prefabricated container house according to the example 1, in the unexpanded state.

FIG. 3 is a horizontal sectional view of the movable prefabricated container house according to the example 1 in a non-expanded state.

FIG. 4 is a sectional view taken along the direction indicated by arrows IV-IV of FIG. 3.

FIG. 5 is a sectional view taken along the direction indicated by arrows V-V of FIG. 4, of the movable prefabricated container house thereof.

FIG. 6 is a horizontal sectional view of the movable prefabricated container house according to the example 1 in an expanded state.

FIG. 7 is a sectional view taken along the direction indicated by arrows VII-VII of FIG. 6.

FIG. 8 is a sectional view taken along the direction indicated by arrows VIII-VIII of FIG. 6.

FIG. 9 is a perspective view showing a step in which floor supporting frames or beams are drawn outward.

FIG. 10 is a perspective view showing a step subsequent to that of FIG. 9.

FIG. 11 is a perspective view showing a step subsequent to that of FIG. 10 and shows ceiling supporting frames or beams for the support of ceiling board drawn out.

FIG. 12 is a perspective view showing a step subsequent to that of FIG. 11.

FIG. 13 is a perspective view showing a step subsequent to that of FIG. 12.

FIG. 14 is a perspective view showing a step subsequent to that of FIG. 13.

FIG. 15 is a perspective view showing a step in which a doorway is formed, this step being subsequent to that of FIG. 14.

FIG. 16 is a perspective view showing a state in which the movable prefabricated container house is set up at an installation site.

FIG. 17 is a perspective view showing a state in which a two-story dwelling is formed.

FIG. 18 is a horizontal sectional view of a movable prefabricated container house according to an example 3 of the present invention in a non-expanded state.

FIG. 19 is a sectional view taken along the direction indicated by arrows XIX-XIX of FIG. 18.

FIG. 20 is a horizontal sectional view of the movable prefabricated container house of FIG. 18 in an expanded state.

FIG. 21 is a sectional view taken along the direction indicated by arrows XX-XX of FIG. 20.

FIG. 22 is a perspective view showing a movable prefabricated container house installed on an installation foundation bodies buried in the ground according to an example 4.

FIG. 23 is a cross-sectional view showing two installation foundation bodies (a) and (b) buried in the ground with the pole body having dampers welded in two places.

FIG. 24 is a cross-sectional view showing a hole bored in the ground for burying the installation foundation body. Liquid cement may be applied to the side of the wall to prevent the side of the hole from caving in before the foundation is inserted.

FIG. 25 is a cross-sectional view showing a state where a buried pipe body is inserted into the hole provided in the ground.

FIG. 26 is a perspective view showing mega structures for movable prefabricated container houses with each mega structure laid horizontally from each other.

FIG. 27 is a perspective view showing a state where floors are placed in the mega structures.

FIG. 28 is a perspective view showing a state where the movable prefabricated container houses are housed in spaces formed in respective floors of the mega structures.

FIG. 29 is a perspective view showing two mega structures facing each other horizontally, and shrouded with wire meshing to render the structure earthquake and hurricane-resistant. Two sets of frames are portrayed, one set of frames in the inside supporting the wire meshing, and one set of frames outside supporting the floors and staircase structures.

FIG. 30 is a perspective view showing a state where a plurality of mega structures is in assembly.

FIG. 31 is a cross-sectional view showing a movable prefabricated container house according to an example 6.

FIG. 32 is a cross-sectional view showing a state where the movable prefabricated container house is expanded/assembled at an installation site.

FIG. 33 is a cross-sectional view showing a state where a floorboard and a ceiling board are connected to a horizontal frame through a rotating part and housed in a main framework member.

FIG. 34 is a cross-sectional view showing a state where the floor board and the ceiling board are expanded by the rotating part.

FIG. 35 is a cross-sectional view showing a state where a unit wall is drawn out of the main frame member and positioned at a drawn-out position by a stopper part.

FIG. 36 is a perspective view showing a state where supporting ceiling and floor frames or beams are drawn out of the horizontal frame in the state where the movable prefabricated container house with pre-assembled square “U”-shape walls is installed at the installation site with the walls sandwiched between the floor and ceiling boards. Wires tying the floor and ceiling beams together with shackles are also displayed.

FIG. 37 is a perspective view showing a state where the movable prefabricated container house is installed at the installation site and selected floor and ceiling boards are expanded on the supporting ceiling and floor frames or beams with wires/cables tying the two beams together with shackles.

FIG. 38 is a perspective view showing a state where the movable prefabricated container house is installed at the installation site and selected ceiling and floor boards are expanded and pipes providing rigidity to the prefabricated “U”-shaped walls running between each set of the prefabricated walls and also the whole length of the house walls is displayed.

FIG. 39 is a perspective view showing a state where the movable prefabricated container house is installed at the installation site and the pre-assembled square “U”-shaped wall is drawn out of the main frame member sandwiched between the ceiling and the floor boards, and pipes providing rigidity to each set of “U”-shaped walls and a pipe providing rigidity to the whole length of the house walls is displayed. An extended floor and ceiling base of the house provides additional support for drawing out the prefabricated “U”-shaped walls.

FIG. 40 is a perspective view showing a state where the movable prefabricated container house is installed at the installation site, the unit pre-assembled square “U”-shape wall is drawn out of the main frame member and sandwiched between the ceiling and floor boards, supported by floor supporting beams and ceiling supporting beams drawn outward, and a pipe providing rigidity to the full length of the house walls is displayed.

FIG. 41 is a perspective view of two sets of inside frames supporting the wire mesh which will provide earthquake- and hurricane-resistant support to the outside frames. Attention is drawn to the small beams (having rollers, see FIG. 43) protruding from the main frames along which the main cables supporting the wire mesh will travel.

FIG. 42 is a perspective view of four sets of frames. The inside set of (two) frames supports the wire mesh while the outside set of (two) frames supports the floors on which the container houses will be placed and anchored.

FIG. 43 is a close-up view of the side of a mega structure made of inside and outside frames.

FIG. 44 is a close-up view of the floor of a mega structure with four brackets for the container house to be mounted and secured with twist-locks against similarly configured mating brackets of the container house.

FIG. 45 is a perspective view of two sets of mega structures constructed horizontally to each other, with tracks laid along the edges upon which a traveling crane sits. The shaded boxes are the container houses mounted on the floors.

### DESCRIPTION OF EMBODIMENTS

### Example 1

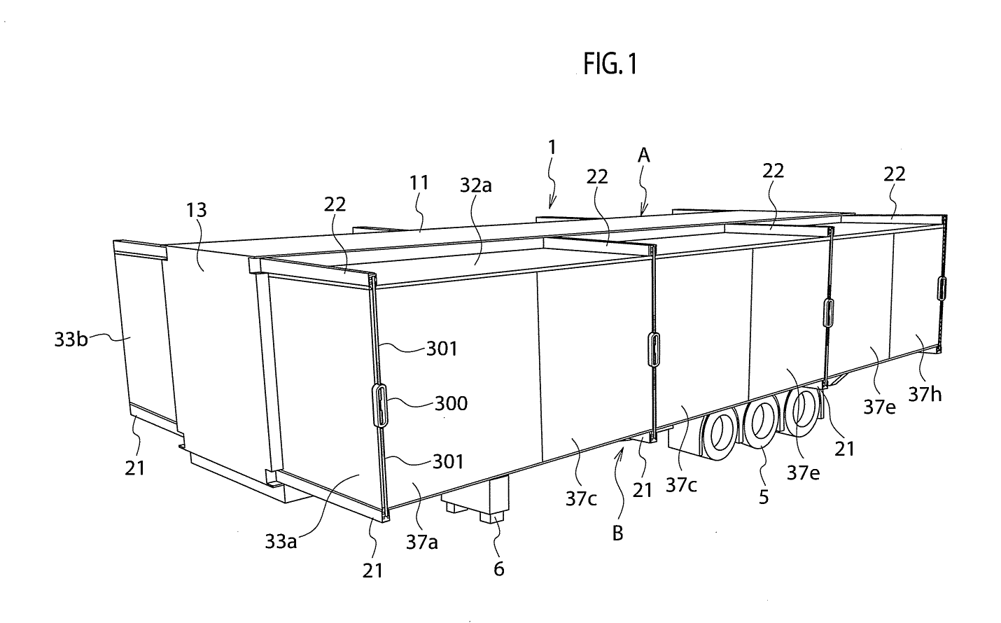

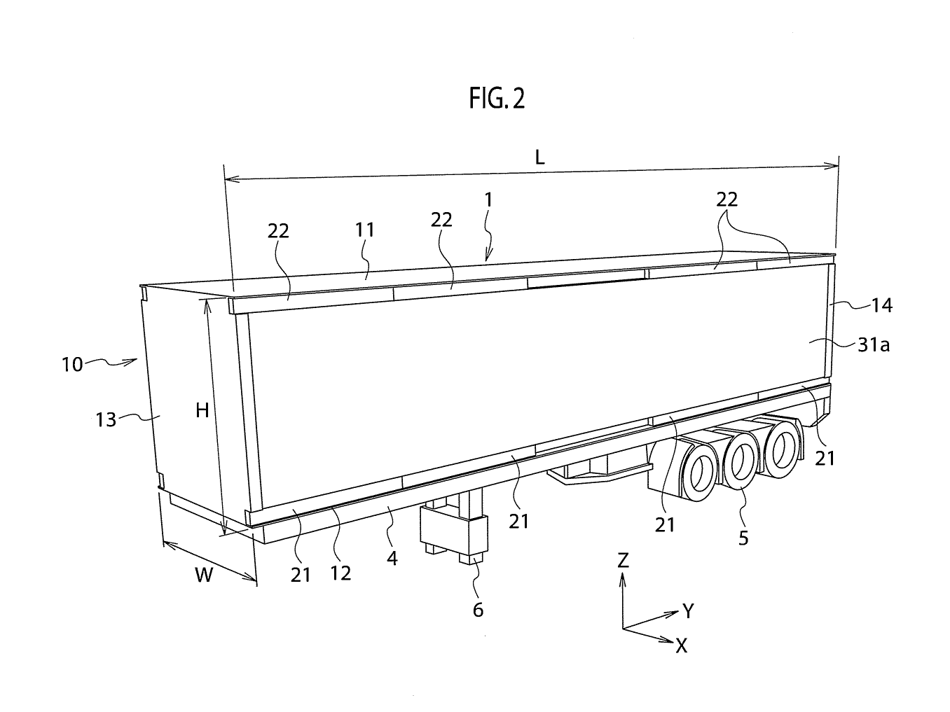

FIGS. 1 and 2 each show a perspective view of an entire configuration of a movable prefabricated container house 1, in open (or drawn) and closed forms, respectively, according to an example 1 of the present invention.

The movable prefabricated container house 1 of the present example includes a main body, A, and a house forming body, B. The main body A can be transported/moved to an installation site. The house forming body B is housed (held) in the main body, transported or moved to the installation site along with the main body A, and thereafter, drawn out of the main body A to be expanded and set up at the installation site.

The movable prefabricated container house 1 is pulled by a trailer truck (semi-trailer truck, not shown) connected to the chassis (wheeled platform). On a lower part of a rear side of the chassis 4, a plurality of wheels 5 are mounted so that the chassis 4 can be pulled. On a lower part of a front side of the chassis 4, a supporting block 6 is mounted. A connection between the trailer truck and the chassis 4 is made by connecting a coupler of the chassis 4 to a kingpin of the trailer truck. The movable prefabricated container house 1 is loaded on the chassis 4 and fastened thereto with a bolt or the like. Thus, the movable prefabricated container house 1 is ready to be pulled by the trailer truck. The movable prefabricated container house 1 can be the size of a 20-foot container, a 40-foot container or a 45-foot container or a 53-foot container. However, the size of the movable prefabricated container house 1 is not limited to these sizes.

At an installation site of destination, the chassis 4 is separated from the trailer truck. Therefore, the movable prefabricated container house 1 is supported and remains stationary on the chassis 4. Then, the movable prefabricated container house 1 supported on the chassis 4 or unloaded from the chassis 4 is expanded and assembled into a dwelling. Hereinafter, description will be given of an example in which the movable prefabricated container house 1 supported on the chassis 4 is expanded and assembled into a dwelling as in the former case. The term “house” herein also includes a meaning of a place of business such as office, shop, health clinic, or hotel room. The term “dwelling” is used herein only for explaining this example as an example. Thus, the movable prefabricated container house 1 may be expanded and assembled into a place of business such as office, shop, health clinic, or hotel room.

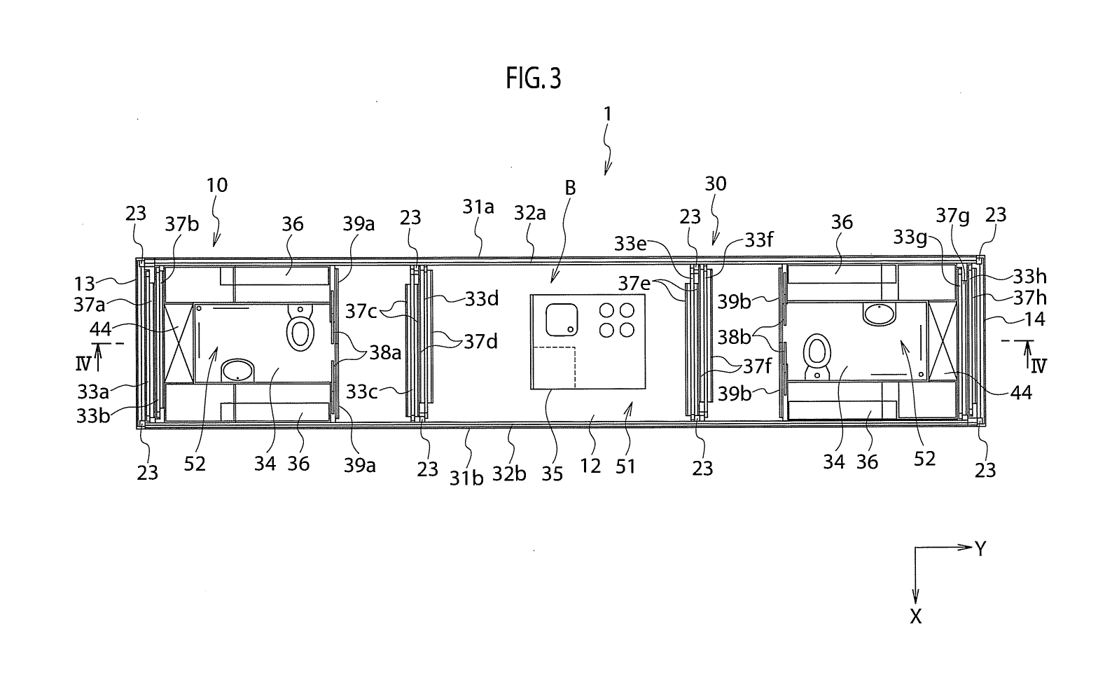

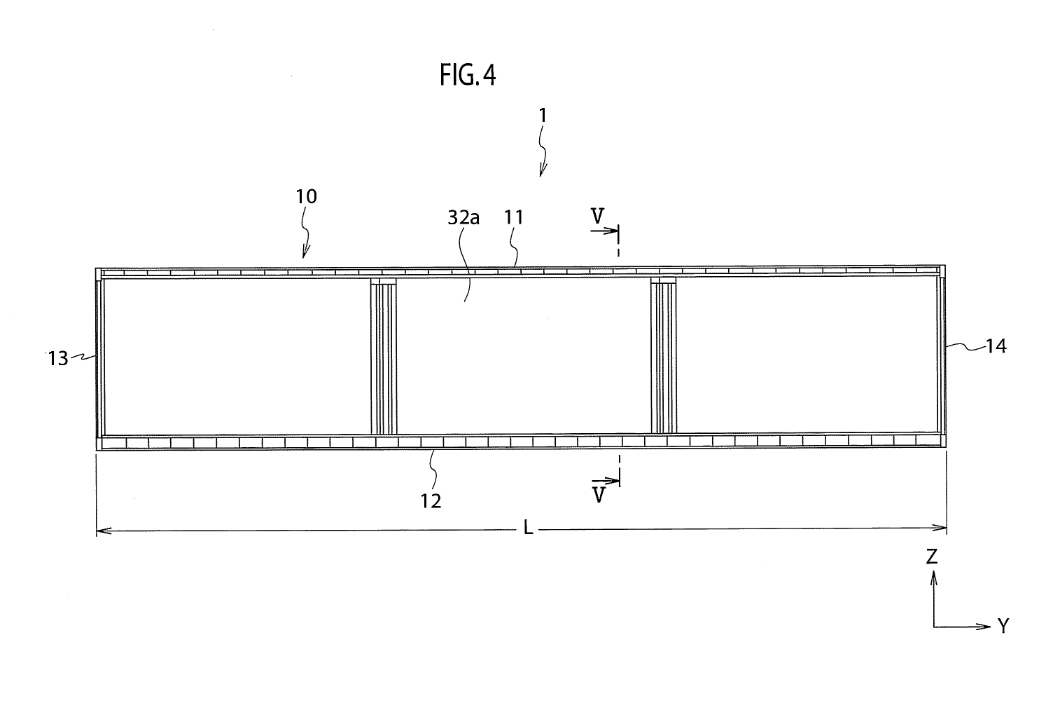

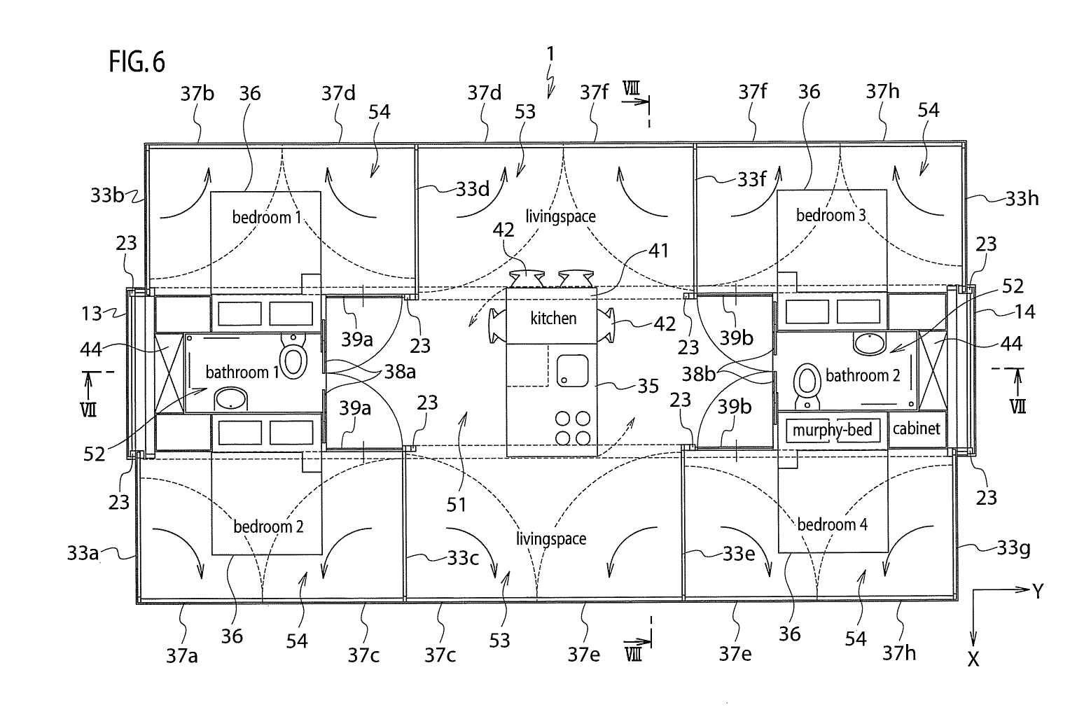

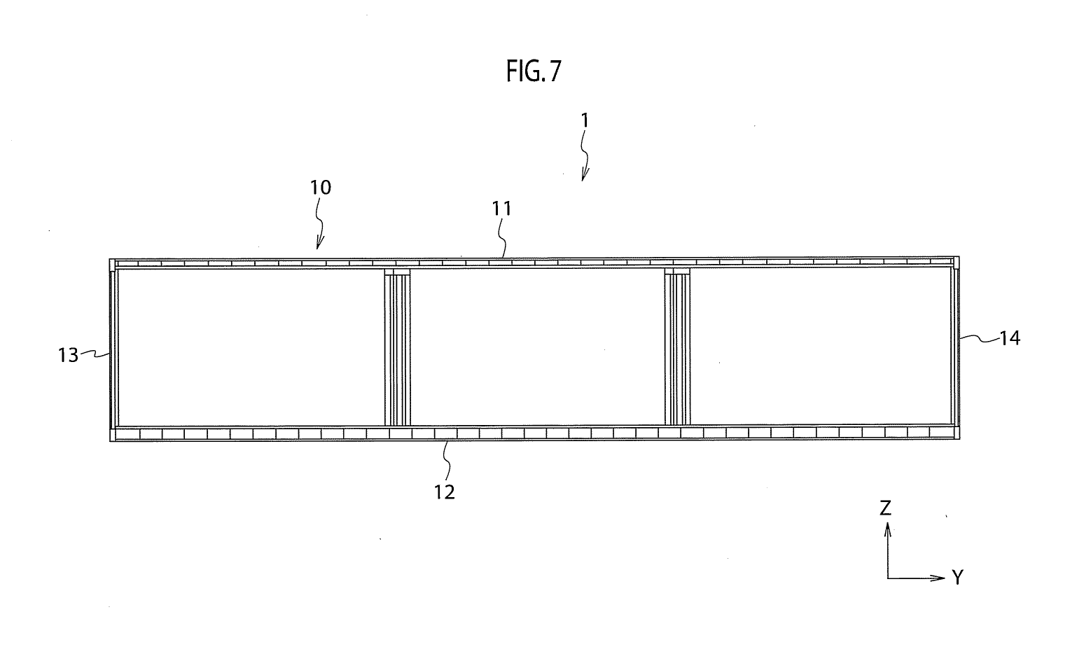

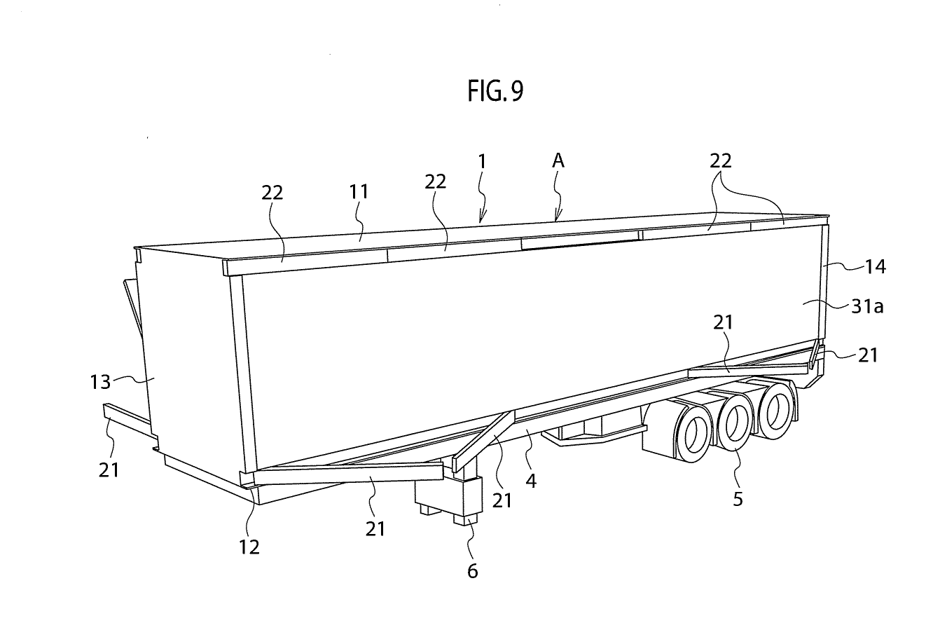

FIGS. 3 to 5 show sectional views each showing the inside of the movable prefabricated container house 1 before being assembled (expanded) into a dwelling. FIGS. 6 to 8 show sectional views each showing the inside of the movable prefabricated container house 1 assembled (expanded) into the dwelling. FIGS. 9 to 16 are perspective views showing assembling (expanding) orders.

For the movable prefabricated container house 1, the main body A includes a main frame member 10, and the house forming body B includes dwelling forming members 30. Further, the movable prefabricated container house 1 of this example includes a sub-frame member 20.

In this example, the sub-frame member 20 and the dwelling forming members 30 to be described later are expanded, whereby the house 1 is formed. The house 1 includes a central kitchen space 51; two bathrooms 52, 52 located on the respective front and rear sides of the kitchen space 51; two living spaces located on the respective left and right sides of the kitchen space 51; and four bedrooms 54 located on the respective left and right sides of each of the bathrooms 52, 52.

As shown in FIGS. 2 to 5, the main frame member 10 is formed of a pair of upper and lower rectangular plate-like horizontal frames 11, 12, and rectangular plate-like vertical frames 13, 14 connecting the pair of horizontal frames 11, 12 at each end thereof. The pair of upper and lower horizontal frames 11, 12, and the front and rear vertical frames 13, 14 are connected so that the main frame member 10 forms a shape like a container. Therefore, the main frame member 10 can be transported by the trailer truck as a normal container.

The pair of horizontal frames 11, 12 are formed of an upper horizontal frame 11 and a lower horizontal frame 12. These horizontal frames 11, 12 have predetermined widths and predetermined lengths. The width is, for example, approximately equal to the width of the kitchen space 51, and the length is, for example, approximately equal to the total length of the kitchen space 51 and the two living spaces 53, 53 on the both sides of the kitchen space 51. These horizontal frames 11, 12 each have a shape long in the horizontal direction. In addition, the horizontal frames 11 and 12 are disposed in parallel to each other. Here, the upper horizontal frame 11 fauns a ceiling of the house 1, and the lower horizontal frame 12 forms a floor of the house 1.

The vertical frames 13, 14 are formed of a front vertical frame (a vertical frame to be located on the front side when loaded on the trailer truck) 13 connecting the horizontal frames 11, 12 at the front ends thereof in the vertical direction, and of a rear vertical frame (a vertical frame to be located on the rear side when loaded on the trailer truck) 14 connecting the horizontal frames 11, 12 at the rear ends thereof in the vertical direction. The front vertical frame 13 forms a front wall of the house 1, and the rear vertical frame 14 forms a rear wall of the house 1.

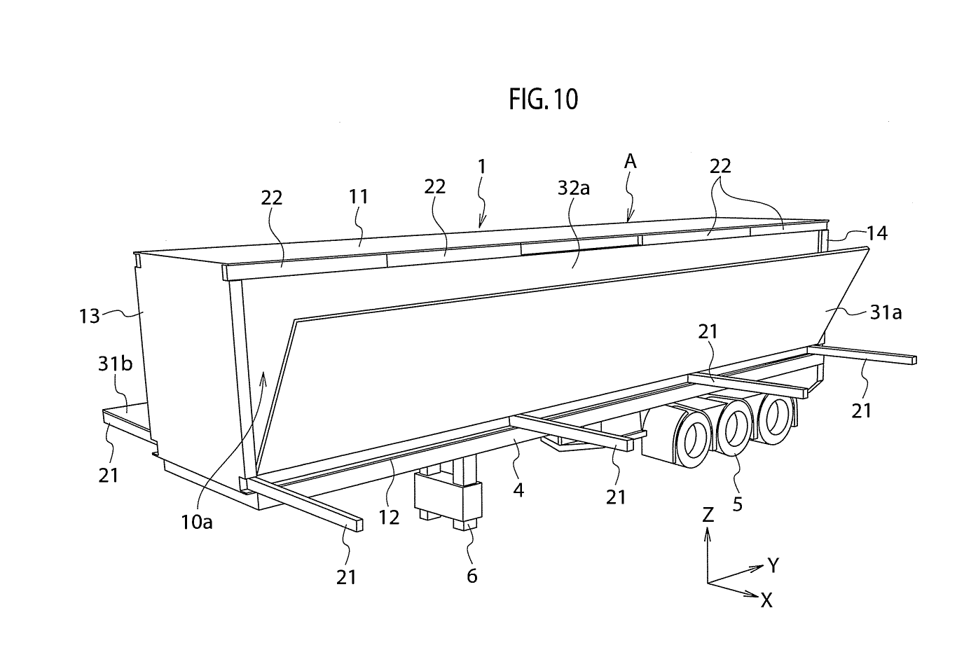

As described above, the main frame member 10 is formed by connecting both ends of the horizontal frames 11, 12 that are long in a front and rear direction using the vertical frames 13, 14, so that the main frame member 10 as a whole forms a (rectangular) box shape with openings 10a (see FIG. 10) on each side thereof.

In the house 1, an outer shell is formed of the horizontal frames 11, 12 and the vertical frames 13, 14. Therefore, the horizontal frames 11, 12 and the vertical frames 13, 14 are formed from a material with a strength being equal to or larger than a predetermined value. As the material, for example, a plate having a predetermined thickness such as a flat steel plate or a corrugated steel plate; a resin plate; a sandwich plate which a heat insulating material is interposed between the foregoing steel plates or the like; or a layered plate in which an heat insulating material is layered on a surface of the foregoing steel plate can be selected. Use of a heat insulating material enables the inside and outside of the house 1 to be thermally insulated from each other, thus improving comfortableness of the house 1.

The sub-frame member 20 includes a plurality of floor supporting frames (beams) 21 and a plurality of ceiling supporting frames (beams) 22. The floor supporting frames 21 and the ceiling supporting frames 22 are beams of steel or the like.

As shown in FIG. 2, the floor supporting frames 21 are disposed on both sides of the lower horizontal frame 12 in the width direction (X axis direction in FIG. 2) thereof, and the ceiling supporting frames 22 are disposed on both sides of the upper horizontal frame 11 in the width direction thereof (however, the floor supporting frames 21 and the ceiling supporting frames 22, both on the left side when viewed from the trailer truck side, are omitted in the drawing). The plurality of floor supporting frames 21 are disposed on an upper part of the lower horizontal frame 12 in its longitudinal direction (Y axis direction in FIG. 2). The plurality of ceiling supporting frames 22 are disposed on a lower part of the upper horizontal frame 11 in its longitudinal direction. When housed, the floor supporting frames 21 and the ceiling supporting frames 22 are disposed so as not to protrude from the corresponding lower horizontal frame 12 or the upper horizontal frame 11. That is, the floor supporting frames 21 and the ceiling supporting frames 22 are housed in the main frame member 10 in a housed state, and can be drawn outward, as shown in FIG. 1, when used.

Each of the plurality of floor supporting frames 21 has an un-illustrated pivot on an end in the longitudinal direction, and is rotatably connected to the lower horizontal frame 12 with the pivot. As shown in FIG. 9, each of the floor supporting frames 21 is about the pivot, so as to be drawn outward from the lower horizontal frame 12. The floor supporting frames 21 thus drawn extend horizontally in parallel to each other, as shown in FIG. 1. Further, the floor supporting frames 21 are rotationally fixed with a bolt, a hook, a twist-lock, or the like, so that the drawn floor supporting frames 21 are kept drawn outward. The drawn and fixed floor supporting frames 21 support thereon floor plates 31 to be described later.

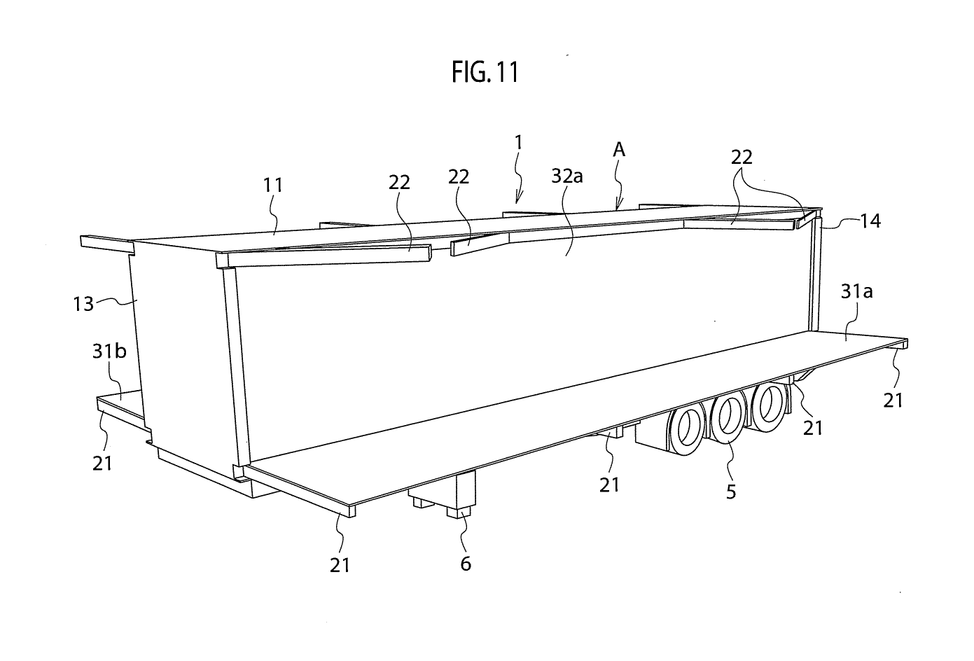

Similarly, each of the plurality of ceiling supporting frames 22 has an un-illustrated pivot on an end in the longitudinal direction, and is rotatably connected to the upper horizontal frame 11 with the pivot. As shown in FIG. 11, each of the ceiling supporting frames 22 is rotated about the pivot, so as to be drawn outward from the upper horizontal frame 11. The ceiling supporting frames 22 thus drawn extend horizontally in parallel to each other, as shown in FIG. 1. Further, the ceiling supporting frames 22 are rotationally fixed with a bolt, a hook, or the like, so that the drawn ceiling supporting frames 22 can be kept drawn outward. The drawn and fixed ceiling supporting frames 22 support ceiling plates 32 to be described later.

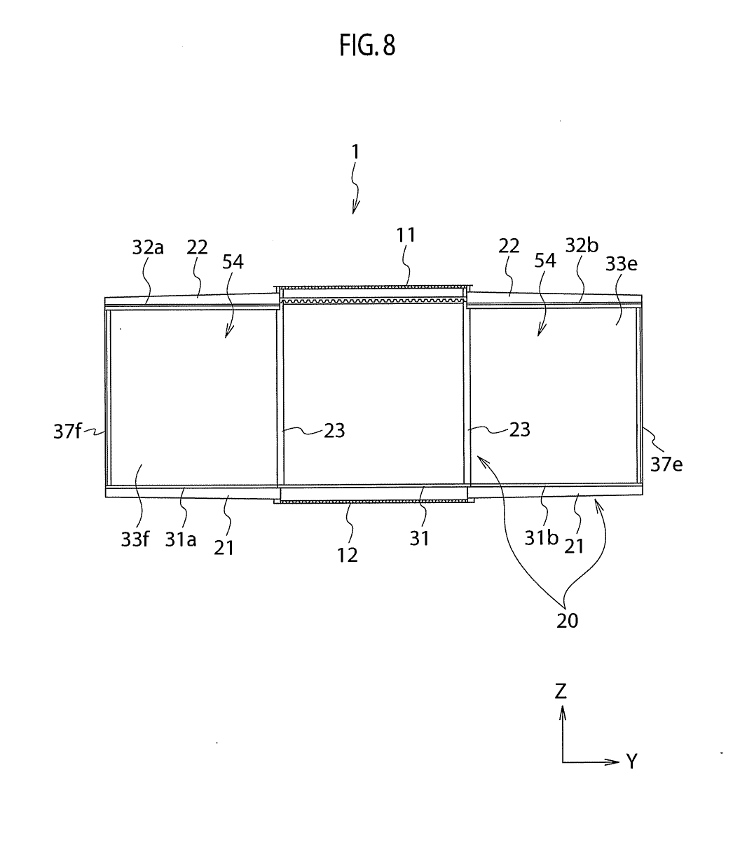

The sub-frame member 20, further includes reinforcing columns 23. As shown in FIG. 8, the reinforcing columns 23 are disposed in the vertical direction between the upper horizontal frame 11 and the lower horizontal frame 12. In addition, as shown in FIGS. 3 and 6, the reinforcing columns 23 are disposed at predetermined intervals in the longitudinal directions of the upper horizontal frame 11 and the lower horizontal frame 12. The reinforcing columns 23 are disposed in the above-described manner so as to reinforce the upper horizontal frame 11 and the lower horizontal frame 12, i.e., the main frame member 10, in the longitudinal direction thereof. Accordingly, even when the main frame member 10 is made longer, the main frame member 10 can securely maintain its box shape, with neither an inflection nor a deflection occurring in the upper horizontal frame 11 and the lower horizontal frame 12 in the middle thereof. In this example, the reinforcing columns 23 are disposed on positions on which respective spaces of the house 1 are partitioned. The dwelling forming members 30 to be described later is disposed in the main frame member 10, while using the reinforcing columns 23 as guide points. Subject to engineering with attention to overall strength of the main body (the container) and configuration (how many bodies or containers will be stacked on the main body), the reinforcing columns may be designed so that the columns can be moved to the edge or the sides of the containers or even be removed thereby providing clear and unobstructed, or nearly such, space within the containers.

The dwelling forming members 30 include movable floor boards 31 (31a, 31b), movable ceiling boards 32 (32a, 32b), movable wall panels 33 (33a to 33h), bath/toilet units 34, a kitchen unit 35, and bed units 36.

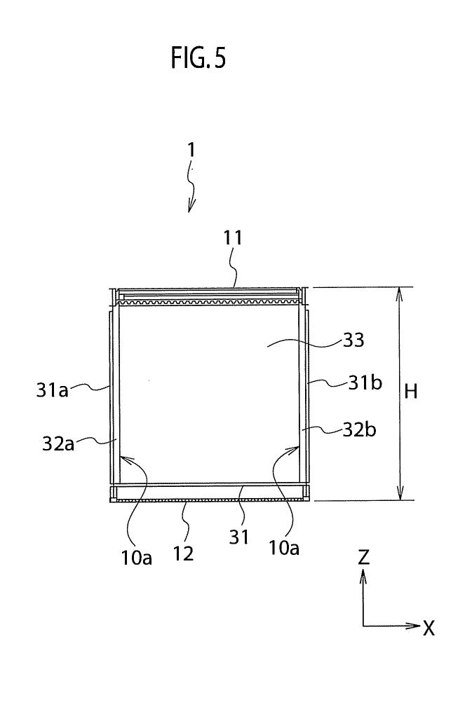

As shown in FIG. 5, the floorboards 31 are formed of a right movable floor board 31a located on the right side of the main frame member 10, and a left movable floor board 31b located on the left side thereof. In the same manner, the ceiling boards 32 are formed of a right movable ceiling board 32a located on the right side of the main frame member 10, and a left movable ceiling board 32b located on the left side thereof.

In this example, the lengths in the Y axis direction of the right floorboard 31a, the right ceiling board 32a, the left floorboard 31b, and the left ceiling board 32b are each substantially the same as the lengths L in the Y axis direction of the upper and lower horizontal frames 11, 12 of the main frame member 10; and the heights thereof (widths thereof at the time when they are expanded) are each substantially the same as heights H of the vertical frames 13, 14 on the front and rear sides of the main frame member 10. Therefore, the right floorboard 31a, the left floorboard 31b, the right ceiling board 32a, and the left ceiling board 32b have sizes and shapes so that these floorboards and ceiling boards are fit into the rectangular openings 10a formed by the main frame member 10. Thus, in transporting the house 1, the floor boards 31a, 31b work as lids (covers) with which the openings 10a of the main frame member 10 are closed. These floor boards 31a, 31b, and the ceiling boards 32a, 32b are formed, for example, of metallic plates such as steel plates or aluminum plates, resin plates, wooden plates, or the like.

As shown in FIG. 5, when the house 1 remains unexpanded (before expanding), the right floor board 31a and the right ceiling board 32a with the foregoing shapes and sizes are housed so that the right floor board 31a and the right ceiling board 32a overlap within the opening 10a on the right side of the horizontal frames 11, 12. Meanwhile, the left floor board 31b and the left ceiling board 32b are housed so that the left floor board 31b and the left ceiling board 32b overlap within the opening 10a on the left side of the horizontal frames 11, 12. In this example, the right floor board 31a and the right ceiling board 32a overlap each other so that the right floor board 31a is located outside the right ceiling board 32a; and the left floor board 31b and the left ceiling board 32b overlap each other so that the left floor board 31b is located outside the left ceiling board 32b (FIGS. 3 and 5). Thus, side walls of the container type dwelling, when transported, can be reinforced. This is because the floor boards 31a, 31b of the dwelling are rigidly formed compared with the ceiling boards 32a, 32b thereof, in general.

The right floor board 31a, the left floorboard 31b, the right ceiling board 32a, and the left ceiling board 32b are overlapped and housed on the left and right sides of the horizontal frames 11, 12 in the above-described manner. Therefore, even when the floor boards 31a, 31b, and the ceiling boards 32a, 32b are even integrated, the size of the house 1 (or the container) in transportation is small and compact.

The overlapped right floor board 31a, the left floor board 31b, the right ceiling board 32a, and the left ceiling board 32b are drawn outward, when the house 1 is expanded. In this example, the movable floor boards 31a, 31b and the movable ceiling boards 32a, 32b include hinge shafts (not shown) at base ends thereof, and the hinge shafts are inserted into the main frame member 10. To be more specific, in the case of the floor boards 31a, 31b, the hinge shafts are inserted into portions of the main frame member 10 under the openings. Meanwhile, in the case of the ceiling boards 32a, 32b, the hinge shafts are inserted into portions of the main frame member 10 over the openings. The floor boards 31a, 31b and the ceiling boards 32a, 32b are drawn outward by rotating or swinging the floor boards 31 and the ceiling boards 32 pivotally about these hinge shafts. Incidentally, in order to rotatably support the floor boards 31a, 31b and the ceiling boards 32a, 32b on the main frame member 10, lower shafts and upper shafts may be provided to respective portions under and over the openings of the main frame member 10, and bearings for the respective shafts may be provided to base portions of the floor boards 31a, 31b and the ceiling boards 32a, 32b.

The wall panels 33 are formed of a first wall panel 33a, a second wall panel 33b, a third wall panel 33c, a fourth wall panel 33d, a fifth wall panel 33e, a sixth wall panel 33f, a seventh wall panel 33g, an eighth wall panel 33h, and outer wall panels 37a to 37h which are rotatably or swingably (pivotally) supported on these wall panels 33a to 33h.

These wall panels 33a to 33h are each formed so as to have a width and a height which are substantially equal to widths W and heights H of the front vertical frame 13 and the rear vertical frame 14 of the main frame member 10. The wall panels 33a to 33h are formed of metallic plates such as steel plates or aluminum plates, resin plates, wooden plates, or the like, similar to the floor boards 31a, 31b and the ceiling boards 32a, 32b.

The first wall panel 33a (and the outer wall panel connected thereto) and the second wall panel 33b (and the outer wall panel connected thereto) form a pair, and are overlapped and disposed near the reinforcing columns 23 on the side of the front vertical frame 13. In the same fashion, the seventh wall panel 33g (and the outer wall panel connected thereto) and the eighth wall panel 33h (and the outer wall panel connected thereto) form a pair, and are overlapped and disposed near the reinforcing columns 23 on the side of the rear vertical frame 14. Similarly, the third wall panel 33c (and the outer wall panels connected thereto) and the fourth wall panel 33d (and the outer wall panels connected thereto) form a pair; and the fifth wall panel 33e (and the outer wall panels connected thereto) and the sixth wall panel 33f (and the outer wall panels connected thereto) form a pair. The paired third and fourth wall panels 33c and 33d (and the outer panels connected thereto), and the paired fifth and the sixth wall panel wall panels 33e and 33f (and the outer panels connected thereto) are overlapped and disposed near the reinforcing columns 23 which support the upper and lower horizontal frames 11, 12 in the middle thereof (refer to FIG. 3). In this manner, these paired wall panels are overlapped and housed in the main frame member 10. Thus, the size of the house 1 (or the container) in transportation is small and compact and in standard size.

As shown in FIG. 6, the first wall panel 33a, the third wall panel 33c, the fifth wall panel 33e, and the seventh wall panel 33g (and the outer panels connected thereto) are slidably movable outward on the left side of the main frame member 10. More precisely, rails engageable with lower edges and upper edges of the wall panels 33 are provided on the upper surfaces of the movable floor boards 31 (31a, 31b) and the lower surfaces of the movable ceiling boards 32 (32a, 32b). Thus, the wall panels 33 drawn outward from the main frame member 10 are guided by the rails and moved in between the movable floor boards 31 (31a, 31b) and the movable ceiling boards 32 (32a, 32b) to be disposed in predetermined positions. Further, the second wall panel 33b, the fourth wall panel 33d, the sixth wall panel 33f, and the eighth wall panel 33h (and the outer panels connected thereto) are slidably movable outward on the right side of the main frame member 10. As described above, the outer wall panels 37a to 37h are rotatably connected to the wall panels 33a to 33h. In the unexpanded house 1, the outer wall panels 37a to 37h are folded so as to overlap the corresponding wall panels 33a to 33h. As shown in FIGS. 1 and 6, in this example, the outer wall panels 37a, 37b, 37g, and 37h, each representing one piece of wall panel, are rotatably connected to the first wall panel 33a, the second wall panel 33b, the seventh wall panel 33g, and the eighth wall panel 33h, which are located on the front and rear sides of the main frame member 10. Meanwhile, the outer wall panels 37c, 37d, 37e, and 37f, each representing two pieces of wall panels, are rotatably connected to the third wall panel 33c, the fourth wall panel 33d, the fifth wall panel 33e, and the sixth wall panel 33f, which are located in the middle of the main frame member 10 in the longitudinal direction thereof. Each pair of two outer wall panels 37c, 37d, 37e, or 37f rotate in opposite directions to each other.

When the house 1 is expanded, the outer walls 37a to 37h each rotate outward. With this rotation, the outer walls 37a to 37h form walls of the house 1. The outer walls 37a to 37h are formed of metallic plates such as steel plates or aluminum plates, resin plates, wooden plates, or the like.

As shown in FIGS. 3 and 6, partition panels 38 (38a, 38b) are disposed in the middle of the upper and lower horizontal frames 11, 12 of the main frame member 10 in the longitudinal direction thereof. The partition panels 38 partition the main frame member 10 into a plurality of sub-spaces in the longitudinal direction thereof. A first partition panel 38a located on the front side of the main frame member 10 forms a bathroom 52 on the front side of the main frame member 10. In this front bathroom 52, a bath/toilet unit 34 is disposed. A second partition panel 38b located on the rear side of the main frame member 10 forms another bathroom 52 on the rear side of the main frame member 10. In this rear bathroom 52, another bath/toilet unit 34 is disposed. In addition, in the bathrooms 52, water storage/drainage tanks 44 are disposed. The water storage/drainage tank 44 is separated into two parts. The upper part thereof is a water storage tank and the lower part thereof is a water drainage tank for the toilet. The provision of the water storage/drainage tank 44 enables the bath/toilet unit 34 to be used.

As shown in FIG. 3 two door panels 39a are disposed near the first partition panel 38a. In addition, two door panels 39b are disposed near the second partition panel 38b. As shown in FIG. 6, these door panels 39a and 39b are supported on the main frame member 10 rotatably about vertical axes. Thus, the door panels 39a, 39b become rotatable when the house 1 is expanded, whereby entrances to the respective bedrooms 54 are formed.

In this example, the four bedrooms 54 are provided at four corners, and each include a bed unit 36 disposed therein. The bed unit 36 is supported on a portion under the opening of the main frame member 10 swingably (pivotally) about a horizontal axis. Accordingly, when the house 1 remains unexpanded (when the house 1 is transported), the bed units 36 are folded in a horizontal position (attitude). In contrast, when the house 1 is expanded, the bed units are drawn down to a horizontal position and can be used as beds.

In this example, the kitchen unit 35 is disposed in the kitchen space 51 at the center of the house 1. The kitchen unit 35 includes a table 41 and chairs 42 which can be drawn therefrom (see FIG. 6). Alternatively, table 41 and chairs 42 provided separately from the kitchen unit 35 may be provided in proximity thereto, when used.

Further, as an entrance from the outside into the house 1, a door may be provided in advance to any one of the outer wall panels 37c, 37d, 37e, and 37f. Further, even when the house 1 is used in the size being equal to that of the main frame member 10 as shown in FIG. 2, the providing of doors for passage, in advance, to outer wall panels and partition panels enables one to get in or out of partitioned spaces.

Next, steps for expanding the movable prefabricated container house 1 of this example are described with reference to FIGS. 9 to 16.

FIG. 9 shows how the floor supporting frames 21 are drawn outward from the main frame member 10 after the state of FIG. 2 in which the chassis 4 has been detached from the trailer truck 2. Each of the floor supporting frames 21 rotates about the pivot so that the floor supporting frame 21 can be drawn outward from the main frame member 10 and extends horizontally.

The floor supporting frame 21 thus drawn is fixed on that position and, thereafter, the left and right (in the X axis direction) floorboards 31a, 31b are drawn outward as shown in FIG. 10. The left and right floorboards 31a, 31b can be drawn by rotating the floorboards 31a and 31b outward and downward about the hinge shafts provided to lower portions. The drawn left and right floorboards 31a, 31b are supported on the floor supporting frame 21 and extend horizontally (refer to FIG. 11).

FIG. 11 shows a step subsequent to that of FIG. 10, and shows how each of the ceiling supporting frame 22 is drawn outward from the main frame member 10. The ceiling supporting frame 22 rotates about the pivot so that the ceiling supporting frame 22 can be drawn outward and extends horizontally. After drawn, the ceiling supporting frame 22 is fixed while extending horizontally.

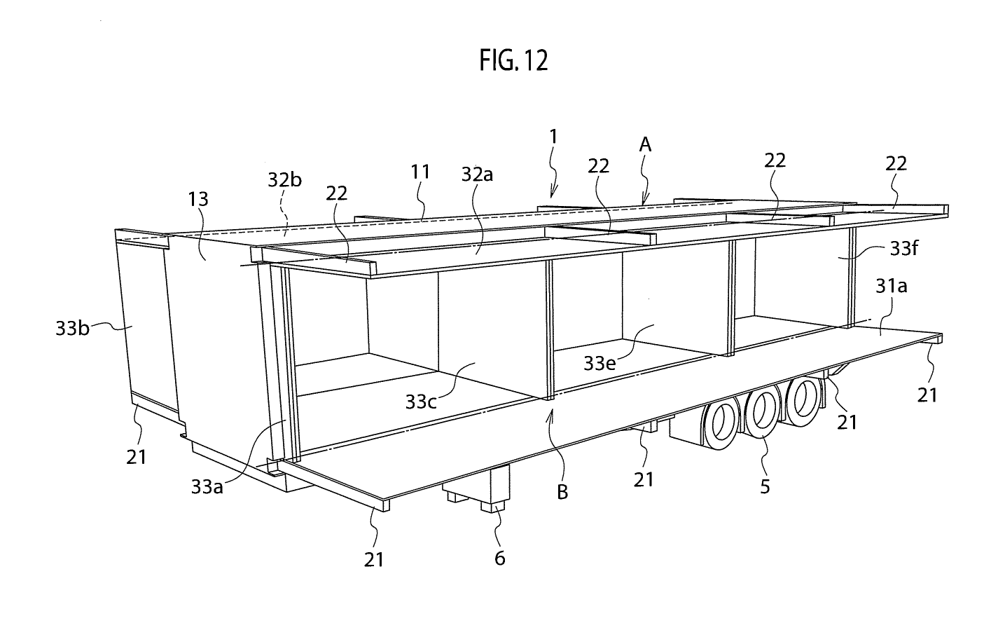

FIG. 12 shows a step subsequent to that of FIG. 11. The left and right ceiling boards 32a and 32b are rotated outward and upward about hinge shafts. As a result of this rotation, the right and left ceiling boards 32a, 32b thus drawn come into contact with the ceiling supporting frames and extend horizontally. These ceiling boards 32a, 32b are fixed to the ceiling supporting frames 22 with bolts, hooks, or the like.

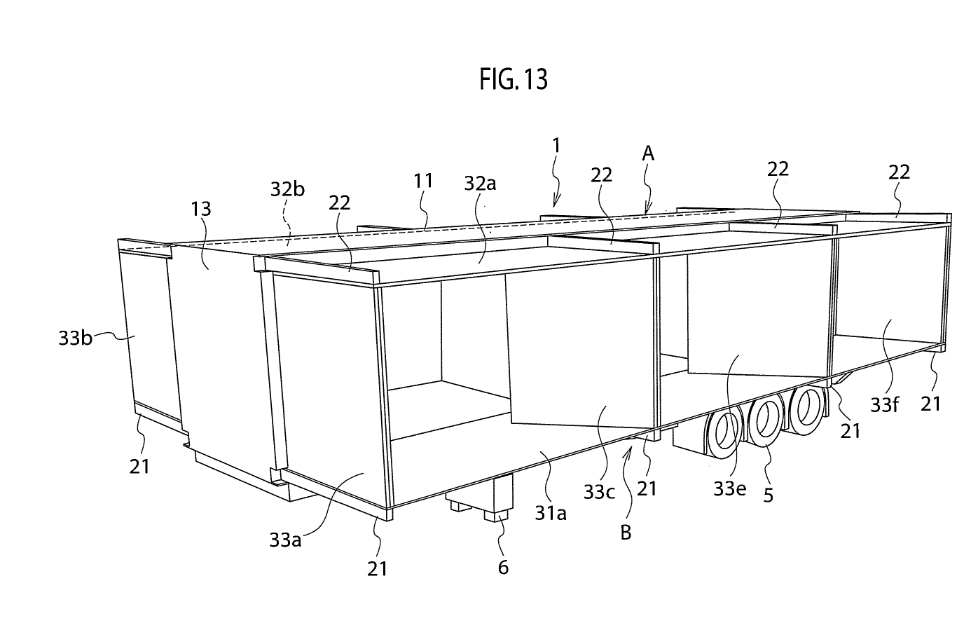

FIG. 13 shows a step subsequent to that of FIG. 12. Each of the wall panels 33a to 33h is slid and drawn outward. Thus, the space inside a room formed with the left and right floorboards 31a, 31b and with the left and right ceiling boards 32a, 32b are partitioned with the wall panels 33c to 33f. Further, the wall panels 33a, 33b and the wall panels 33g, 33h isolate the space inside the room from the space outside the room.

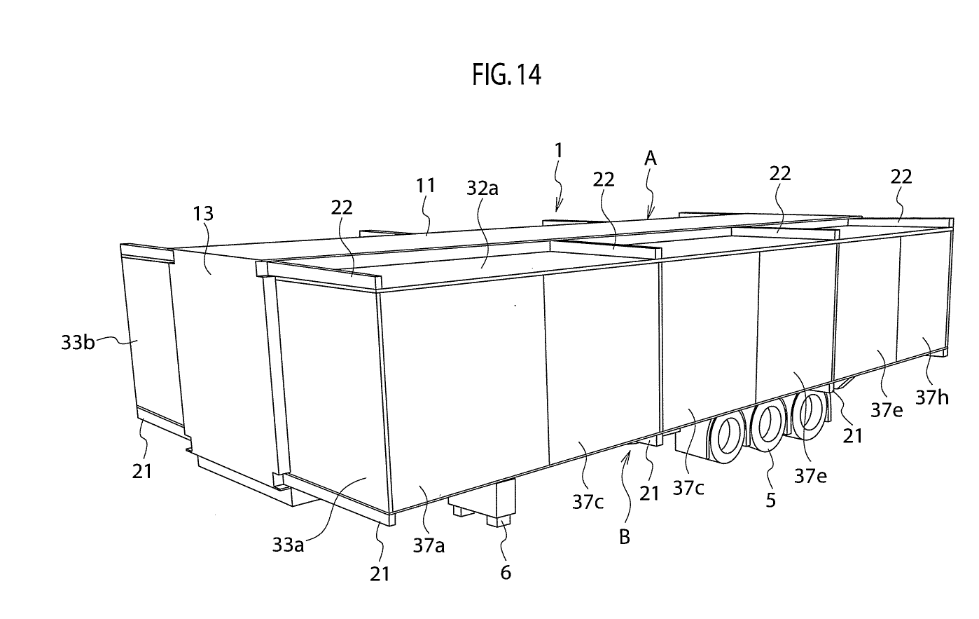

FIG. 14 shows a step subsequent to that of FIG. 13. The outer wall panels 37a to 37h are rotated and drawn outward from the corresponding wall panels 33a. The outer wall panels 37a to 37h drawn outward form outer walls of the house 1 as shown in FIG. 14.

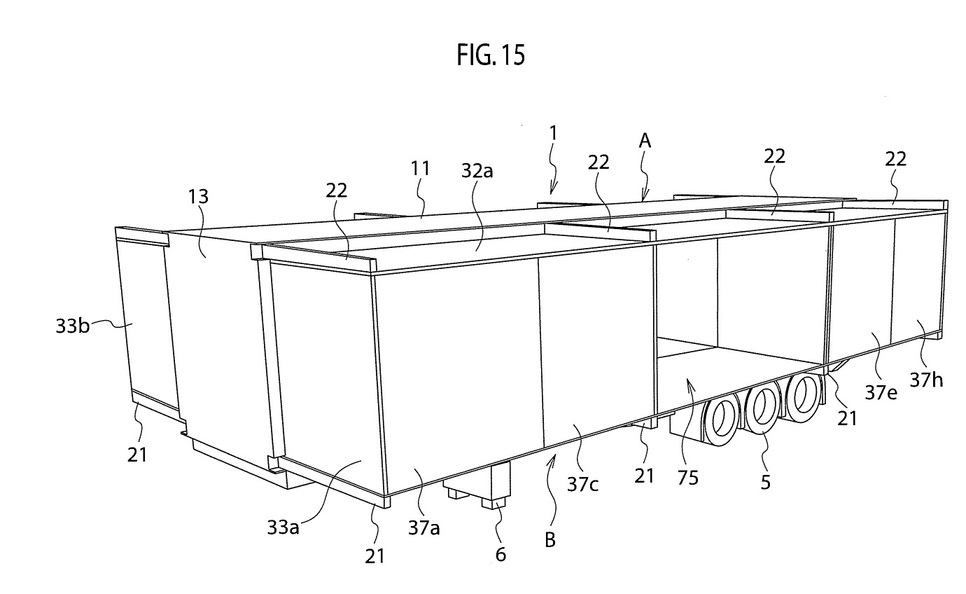

FIG. 15 shows a step subsequent to that of FIG. 14. One of the two outer wall panels 37c of the third wall panel 33c, one of the two outer wall panels 37d of the fourth wall panel 33d, one of the two outer wall panels 37e of the fifth wall panel 33e, and one of the two outer wall panels 37f of the sixth wall panel 33f are rotated into the main frame member 10. As a result of this rotation, an entrance 75 of the house 1 is formed. Here, one of the two outer wall panels 37c of the third wall panel 33c, one of the two outer wall panels 37d of the fourth wall panel 33d, one of the two outer wall panels 37e of the fifth wall panel 33e, and one of the two outer wall panels 37f of the sixth wall panel 33f may not be rotated into the main frame member 10, and a door provided in advance to any one of the outer wall panels 37c, 37d, 37e, and 37f may be used as an entrance of the house 1.

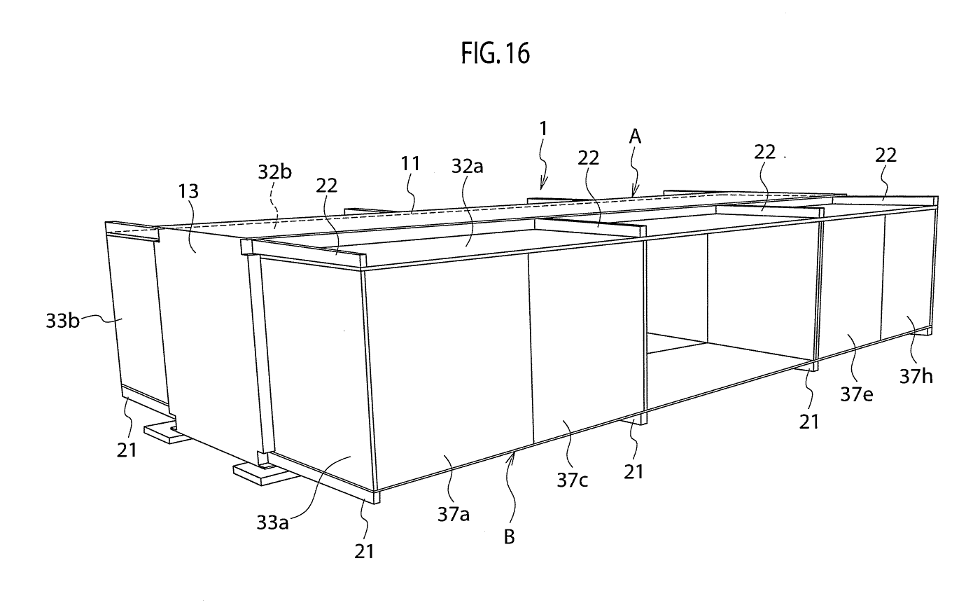

FIG. 16 shows a step in which the house 1 of FIG. 15 with the entrance formed therein is set up on the ground. The entire house 1 is lifted by a crane or the like to be unloaded from the chassis 4, and set on the ground at an installation position. Once a state of FIG. 16 is achieved, it becomes possible for anyone to walk in and out of the house 1.

Incidentally, as described above, the house 1 in the container may be unloaded from the chassis 4 and set on the ground, before the wall panels 33a to 33h are expanded on the floor boards 31a, 31b, and the ceiling boards 32a, 32b. Thereafter, the wall panels 33a to 33h may be expanded on the floor boards 31a, 31b and the ceiling boards 32a, 32b.

Next, as shown in FIG. 16, door panels 39a, 39b are rotated to partition the inside of the house 1 into four bedrooms 54 and also form two living spaces 53. In each of the bedrooms 54, the bed unit 36 is drawn down to a horizontal position for use. Therefore, the house 1 is formed in which the kitchen space 54 is located at the center, two living spaces 54 are disposed on the left and right sides of the kitchen space 51, and two bedrooms 54 are disposed on the front and rear sides of each of the two living spaces 53.

In the example described above, the main frame member 10 of container-type unit serves as an outer shell of the house 1 and the movable prefabricated container house can be used as a dwelling. Accordingly, the amount of cumbersome assembly work at the destination can be reduced to the minimum. Further, since the main frame member 10 can be pulled by the trailer truck 2, the movable prefabricated container house can be moved to any place. In addition, the dwelling forming members 30 housed in the main frame member 10 is easily drawn and assembled. Thus, a plurality of the living spaces 53 and a plurality of the bedrooms 54 can be drawn and formed to the left and right sides of the main frame member 10. Therefore, an easy expansion and assembling of the dwelling are made possible even for non-specialized workers and an extended living space nearly triple the size of the main body can be obtained.

Disassembling the movable prefabricated container house 1 from the state of a dwelling back to the state of a non-expanded container house which can be transported or moved to an installation site as shown in FIGS. 1-5 can be performed by taking reverse procedures to expanding and assembling described above.

### Example 2

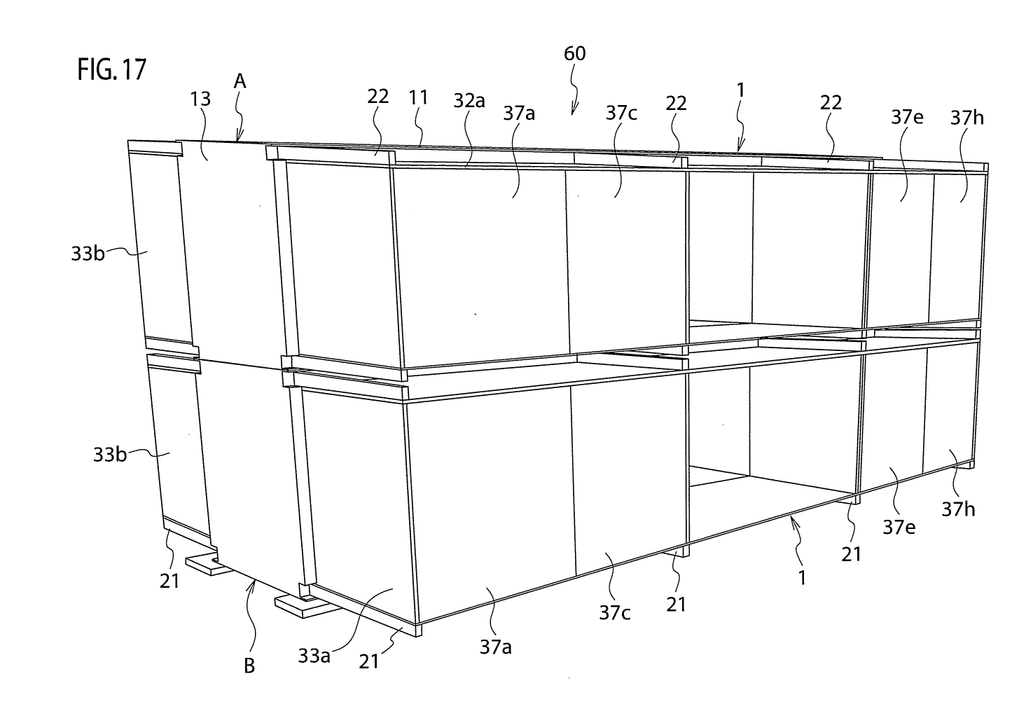

FIG. 17 shows a two-story dwelling 60 formed by stacking the house 1 of the example 1 on another house being the same as the house 1. Upper and lower houses 1, 1 are stacked so that the main frame members 10 can come into contact with each other. The upper and lower houses 1, 1 can be expanded by performing the same operations as those described in the example 1. These expanded houses are stacked vertically and connected, for example, with bolts, twist-locks, or the like. Thus, the two-story dwelling 60 can be formed. In this instance, openings with openable and closable or detachable doors may be provided in a ceiling of the lower house 1 and a floor of the upper house 1 at the corresponding positions of the upper and lower houses 1. And stairs may be placed enabling communications between the upper and lower houses 1. Stairwells with stairs and even an elevator may be set up against the upper house 1 directly from the outside enabling communications between the inside of the upper house 1 and the outside.

In such an example shown in FIG. 17, an extension of the dwelling is simple. Accordingly, a further extended living space can be obtained. In this way, one or more house 1 may be stacked to form a tiered house so that space can be increased according to the number of units placed one on top of the other.

While not shown in the drawings, an auxiliary floor board for extension and an auxiliary ceiling board for extension may be slidably provided to each of the left and right floor boards 31a, 31b and the left and right ceiling boards 32a, 32b. The auxiliary floor boards for extension and the auxiliary ceiling boards for extension are slid and moved outward after all the left and right floor boards 31a, 31b and the left and right ceiling boards 32a, 32b are rotated so as to extend horizontally. The sliding and extending of these auxiliary floor boards and auxiliary ceiling enables the floor boards and the ceiling boards to further extend outward. In this case, the living space is larger than that of the example of FIGS. 1 to 16. Therefore, the dwelling can be extended.

### Example 3

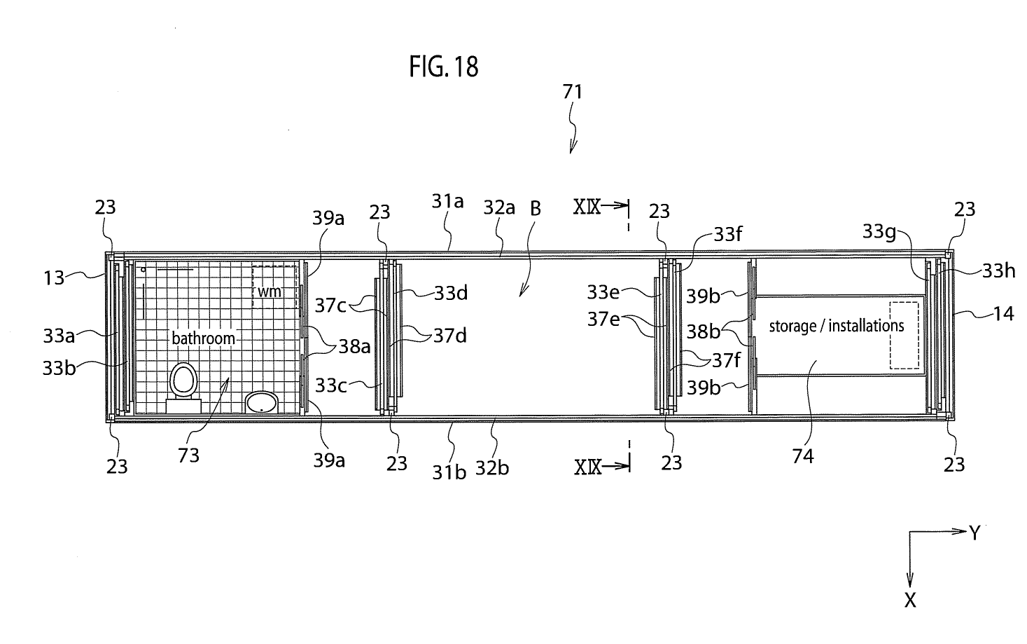

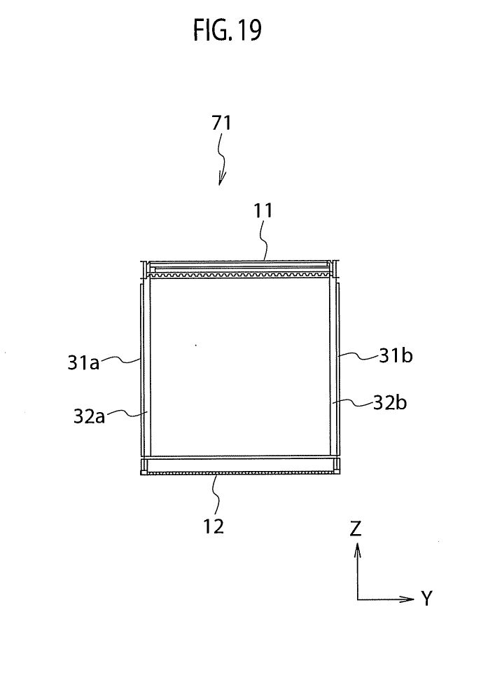

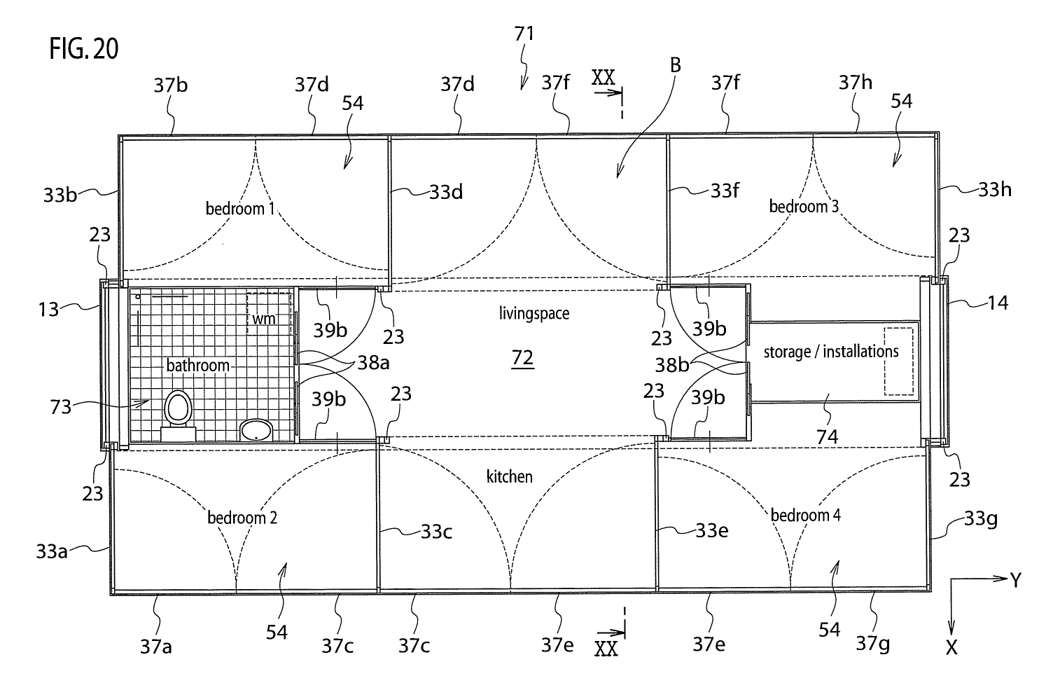

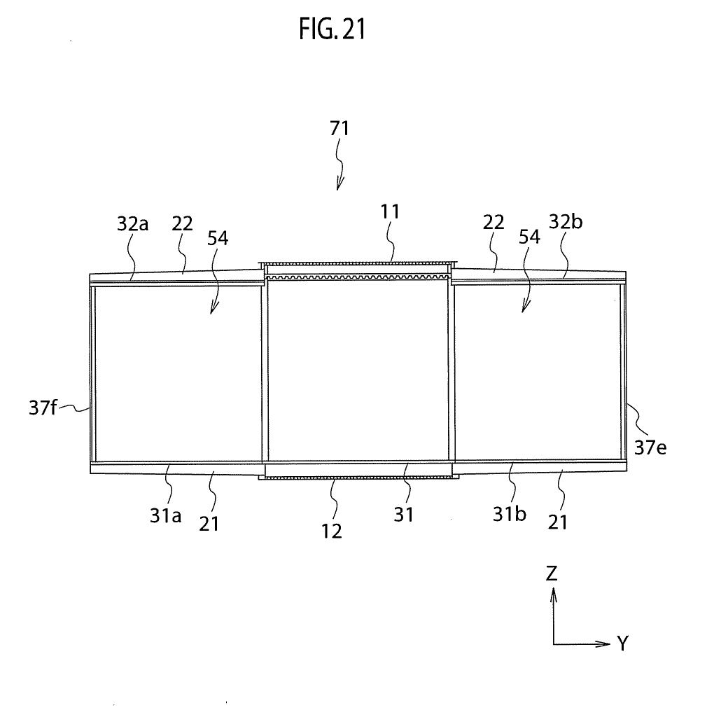

FIGS. 18 to 21 show a movable prefabricated container house 71 of an example 3; FIGS. 18 and 19 show sectional views in an unexpanded state; and FIGS. 20 and 21 show sectional views in an expanded state. In the movable prefabricated container house 71 of the example 3, components which are the same as those of the movable prefabricated container house 1 of the example 1 are given the same symbols.

For the movable prefabricated container house 71, a living space is provided in the middle, and a bathroom 73 is provided on the front side of the living space 72. In addition, a storage 74 is provided on the rear side of the living space 72. The bathroom 73 and the storage 74 are provided inside the main frame member 10 in an unexpanded state of the house 71, so that even when the house 1 is not expanded, the bathroom 73 and the storage 74 can be used as they are. Therefore, the bathroom 73 and the storage 74 can be used even in a state where the movable prefabricated container house 71 is non-expanded and being transported/moved. Accordingly, the movable prefabricated container house 71 can be effectively used even in a state where the movable prefabricated container house 71 is being transported/moved.

The present invention is not intended to be limited to the examples 1 to 3, and various modifications may be made thereto.

For example, the interior spaces of the movable prefabricated container houses 1 and 71 can be modified, when necessary. Further, in the movable prefabricated container house 1 or 71, a solar or wind power electric generator (a solar photovoltaic power generator/a solar thermal power generator/windmill) may be disposed on a ceiling portion. With the solar and/or wind electric power generator electrically connected to the movable prefabricated container house 1 or 71, the solar and/or wind electric power generator is disposed on an exterior portion, so that a power supply for consumer-electronic appliances can be secured. Further, in the movable prefabricated container house 1 or 71, a solar heat collector may be disposed on a ceiling portion. Further, windows may be provided to the outer wall panels 37a to 37h. Thus, ventilation through the windows is made possible in the houses 1, 17. Up to eighty (80) percent of the wall may be made of glass or other transparent or clear materials subject to support and strength determined by engineering design. Further, the floor boards 31a, 31b and the ceiling boards 32a, 32b do not necessarily have rotation structures, but may have slidable structures.

For example, when the house 1 remains unexpanded (before expanding), the right floor board 31a and the right ceiling board 32a may overlap each other so that the right ceiling board 32a is located outside the right floor board 31a; and the left floor board 31b and the left ceiling board 32b may overlap each other so that the left ceiling board 32b is located outside the left floor board 31b. This configuration can give a good capability in waterproof against rain and the like to the movable prefabricated container house 1 when the movable prefabricated container house 1 is transported or expanded. In addition, the right ceiling board 32a and the left ceiling board 32b functioned as a ceiling/roof can be expanded prior to or regardless of the expansion of the right floor board 31a and the left floor board 31b. Therefore, with the above configuration, assemblers can expand/assemble the movable prefabricated container house 1 into a dwelling without letting themselves and the right floor board 31a and the left floor board 31b be exposed to the rain when it is raining after the expansion of the right ceiling board 32a and the left ceiling board 32b. Further, the movable prefabricated container house 1 can be used only with the expansion of the right ceiling board 32a and the left ceiling board 32b functioned as a ceiling/roof shutting out the rain or the sunlight when the movable prefabricated container house 1 is used without the expansion of the right floor board 31a and the left floor board 31b. Therefore, the above configuration can give a large repertoire of the usage of the movable prefabricated container house 1.

### Example 4

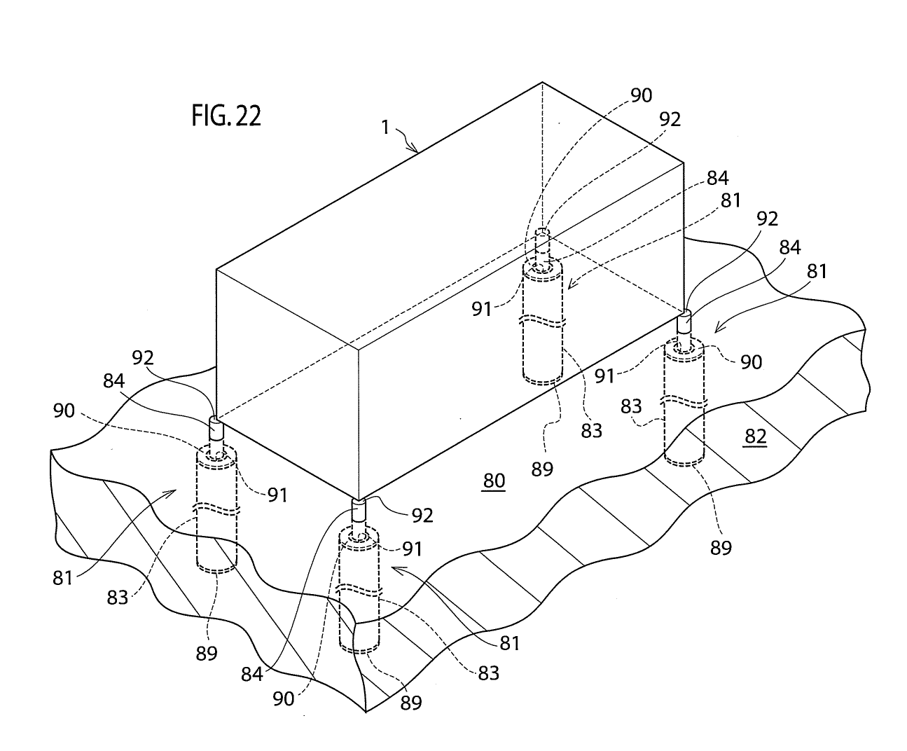

Next, with reference to FIGS. 22 to 26, description will be given of installation foundation bodies 81 provided at an installation site 80 in installation of a movable prefabricated container house 1 according to this example.

As shown in FIG. 22, each of the installation foundation bodies 81 includes: a buried pipe body 83 buried in the ground 82; a pole body 84 provided upright in the buried pipe body 83 in a state where a tip portion thereof protrudes from the ground.

The buried pipe body 83 includes: a cylindrical peripheral wall part 86 having a hollow inside; a lower movable cover body 89 connected to the peripheral wall part 86 through a rotating part 87 at a lower end of the peripheral wall part 86 and capable of opening and closing a lower side opening 88 of the peripheral wall part 86; and an upper stationary cover body 90 having in the underside rubberized O-ring provided at an upper end of the peripheral wall part 86 to close the inside of the peripheral wall part 86. In the upper stationary cover body 90, a through-hole 91 is provided, through which the pole body 84 passes.

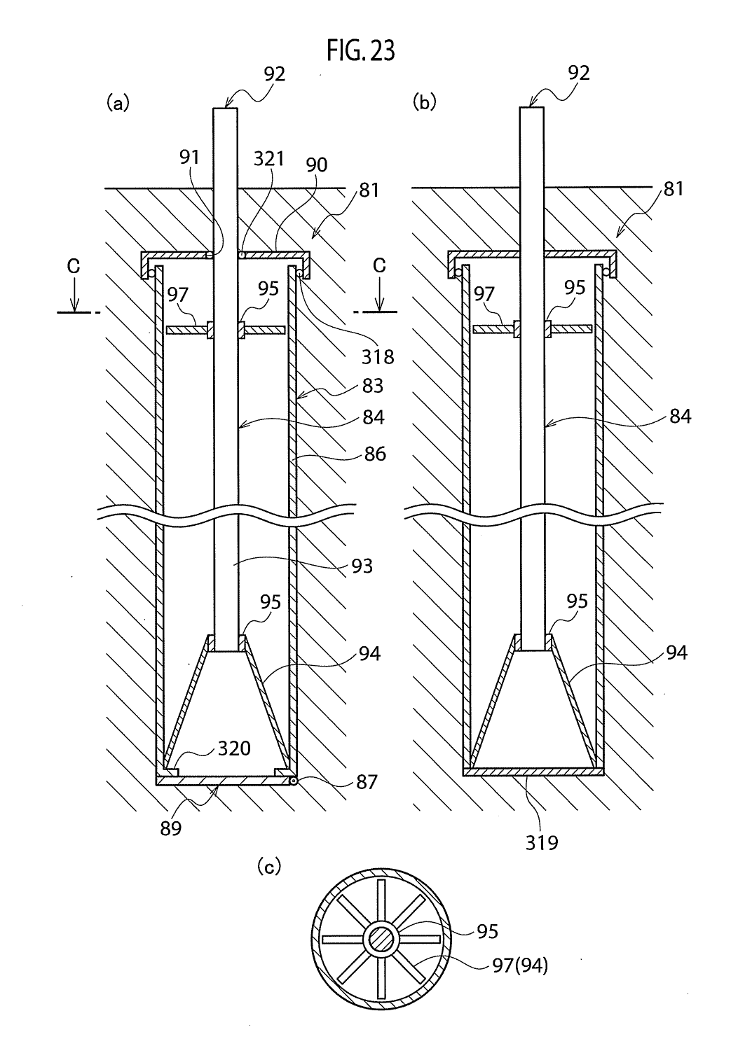

The pole body 84 is formed of a rod-shaped pole main body 93 having a mounting surface 92 formed at its tip, on which the movable prefabricated container house 1 is mounted, and pole supporting members 94 supporting the pole main body 93 inside the buried pipe body 83. Each of the pole supporting members 94 is formed of a ring-shaped connection part 95 fixed to a periphery of the pole main body 93 and supporting arms 97 having one side fixed to the connection part 95 and the other side supported by an inner wall 96 of the peripheral wall part 86. A plurality of the supporting arms 97 and supporting members 94 are provided radially at regular intervals in a circumferential direction of the connection part 95 as illustrated in FIG. 23(c).

The installation foundation bodies 81 having the above configuration are buried in the ground so as to correspond to four corners of the movable prefabricated container house 1 as shown in FIG. 22, and the movable prefabricated container house 1 is mounted on the mounting surfaces 92 of the pole main bodies 93 protruding from the ground.

Next, with reference to FIGS. 23 to 25, description will be given of procedures for installing the installation foundation bodies 81.

FIG. 23 shows two installation foundation bodies (a) and (b) buried in the ground with the pole body having dampers welded in two places 95, one set 97 perpendicular to the pole body 93 and the other set 94 at the bottom of the pole body at an angle of about 45 degrees, (c) being the cross-sectional view of the pole bodies, and the lid 89 attached to the pipe body 83 with a hinge 87 closed, and with a seal at the top of the pipe body 83 and the pole body 84 with the mounting end 92 of the container house protruding.
(a) Pipe body has an O-ring 321 between the pole body 84 and the upper stationary cover body 90 (about the through-hole 91), O-ring 318 between the upper stationary cover body 90 and the pipe body 83, and dampers 94 at approximately 45-degrees at the end of the pole body 84 sitting on a rim 320 welded to the pipe body, and the lid 89 is attached to the pipe body 83 with a hinge 87.
(b) Pipe body has an O-ring 318 between the upper stationary cover body 90 and the pipe body 83. The dampers 94 at approximately 45-degrees sit on a lid 319 which is welded to the pipe body 93.

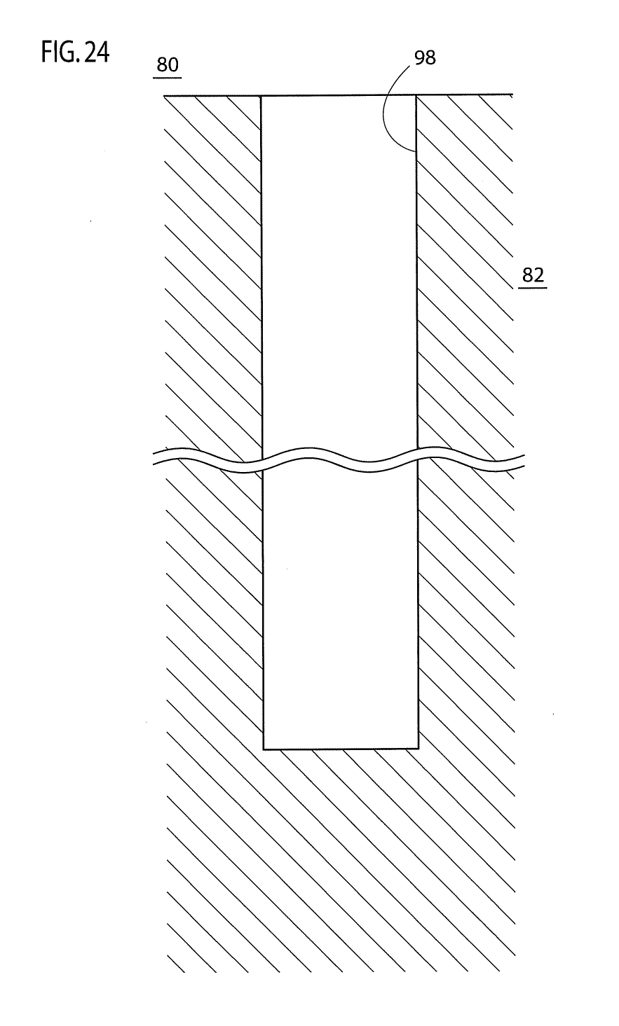

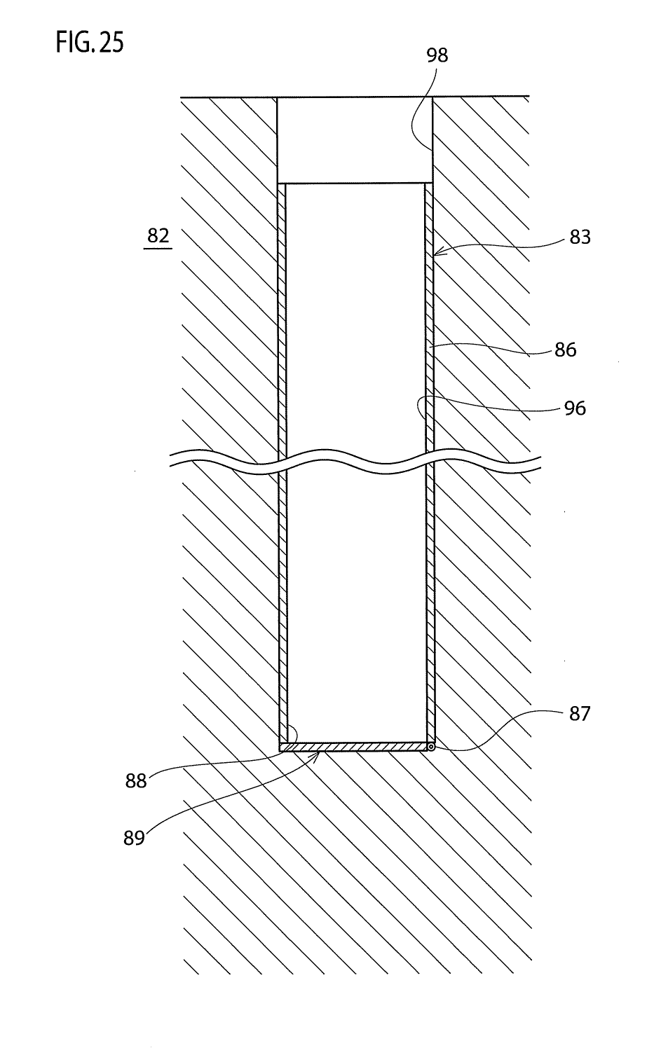

As shown in FIG. 24, a hole 98 having a diameter slightly larger than that of the buried pipe body 83 is dug by boring in the ground on which the movable prefabricated container house 1 is to be placed. Thereafter, as shown in FIG. 25, the buried pipe body 83 is inserted into the hole 98 so as not to open the lower movable cover body 89, unless the cover has been welded to the pipe body, i.e. as shown in (b) of FIG. 23. After inserting the buried pipe body 83 into the hole 98, the pole body 84 is inserted into the buried pipe body 83. In this event, a depth of the hole 98, in which the buried pipe body 83 is installed, is previously set so as to allow the tip of the pole main body 93 to protrude from the ground 82.

From this state, the pipe body 83 is buried, covered with soil as shown in FIG. 23. In this event, the tip of the pole main body 93 protrudes from the ground and the mounting surface 92 protrudes at a predetermined position from the ground. As described above, the installation foundation bodies 81 are buried in the ground so as to correspond to the four corners of the movable prefabricated container house 1. Thereafter, the tip of the pole main body 93 is allowed to protrude from the ground, and the mounting surfaces 92 of the respective pole main bodies 93 are set at the same height. Subsequently, the movable prefabricated container house 1 is mounted on the mounting surfaces 92.

After recovering the movable prefabricated container house 1 from the installation site, the buried pipe body 83 may be drawn out of the ground (not shown) together with the pole body 84.

### Example 5

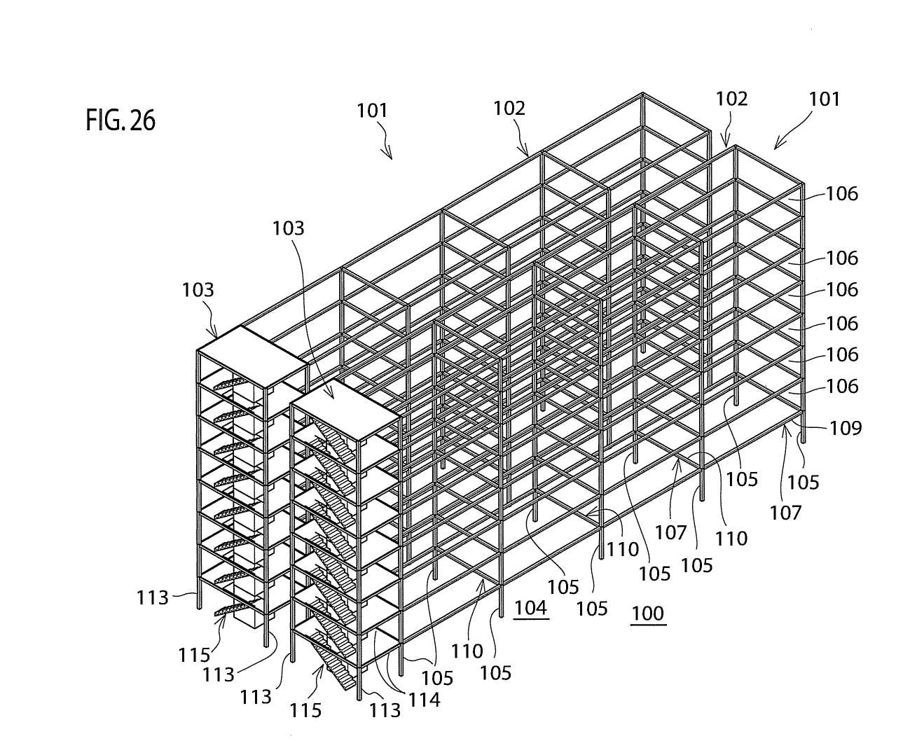

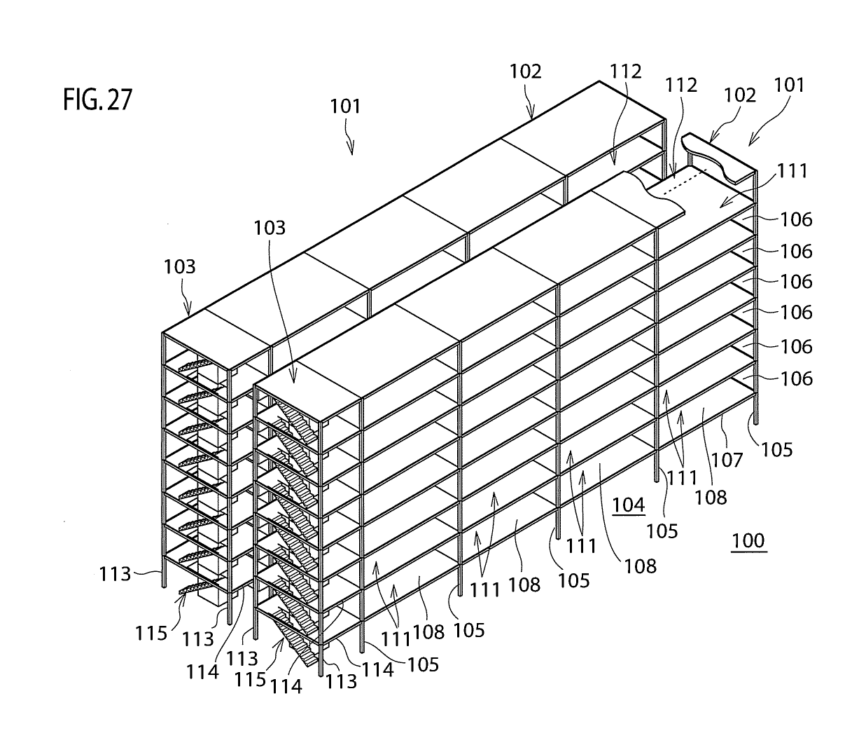

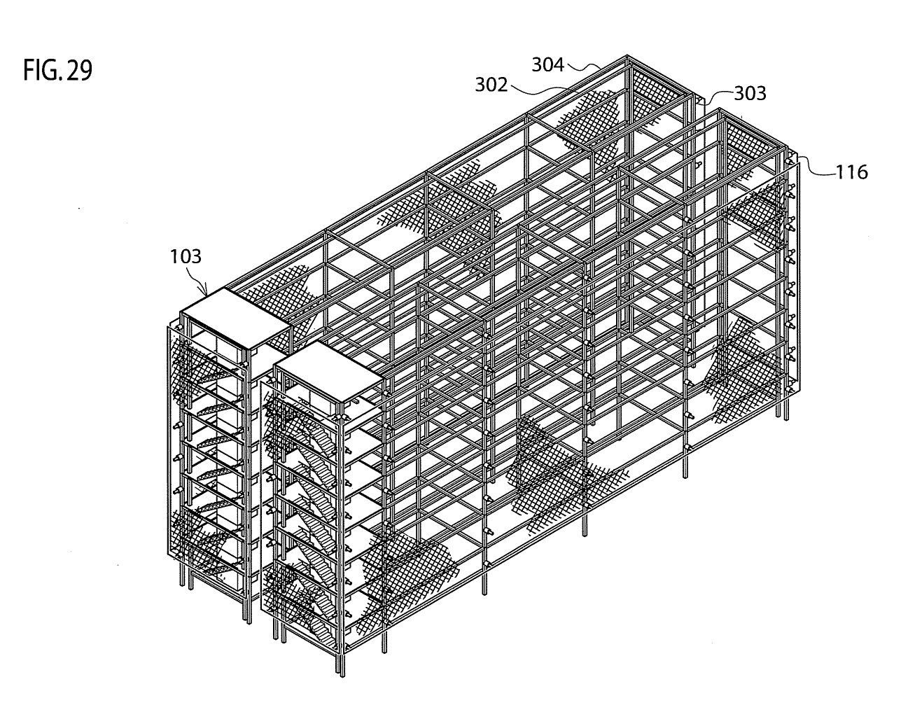

Next, with reference to FIGS. 26 to 30, description will be given of an example 5 in the case where a plurality of the houses 1 is used forming conjunction with mega structures.

In example 5 a mega structure assembly having a plurality of the movable prefabricated container houses 1 described above is installed in a limited site. The mega structure can be formed by installing two identical structures in a position facing each other horizontally with a crane straddling the two structures at the top of the structures on tracks laid along the inner edges of structures.

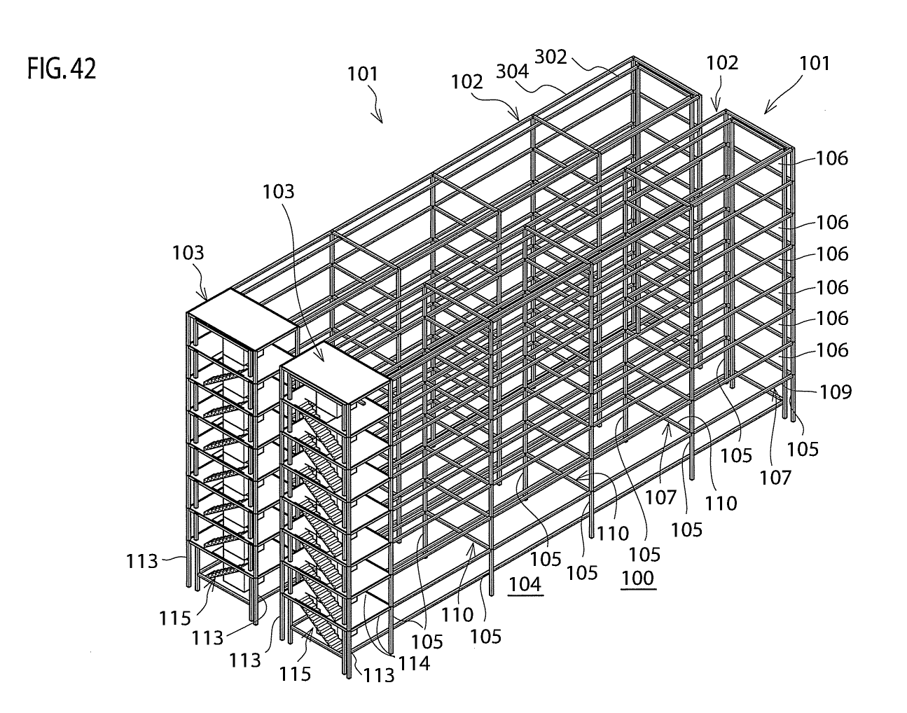

As shown in FIGS. 26-29, the movable prefabricated container houses 1 according to this example are built into mega structures 101 formed at an installation site 100 and are placed three or more stories high. Each of the mega structures 101 includes a housing structure part 102 for housing the container houses 1 and a staircase structure part 103 placed adjacent to the housing structure part 102. Additional features of the mega structures are discussed with respect to FIG. 42.

The housing structure part 102 includes: a plurality of pillar members 105 provided upright from the ground 104; beam members 107 connecting the pillar members 105 and defining spaces 106 for housing the containers 1 with the pillar members 105 assembled into a grid-like structure; and floors or floorboards 108 on which the container houses 1 housed in the spaces 106 are mounted, the floorboards 108 being supported by the beam members 107.

The beam members 107 include: framework beam members 109 forming a framework together with the pillar members 105; and container supporting beam members 110 connected between the framework beam members 109 and supporting the floors 108. Each of the floors 108 includes: a container mounting part 111 on which the movable prefabricated container house 1 is mounted; and a corridor forming part 112 adjacent to the container mounting part 111. This corridor forming part 112 is connected to the staircase structure part 103. Thus, it is possible to go to the corridor forming part 112 at each stage through the staircase structure part 103.

The staircase structure part 103 includes pillar members 113, beam members 114 and staircase units 115 provided in spaces defined by the pillar members 113 and the beam members 114.

Moreover, on outer peripheral portions of the structures 101, protection nets 116 covering side surfaces of the structures 101 are provided. The protection nets 116 help provide protection against earthquakes and hurricanes.

Next, description will be given of procedures by which the movable prefabricated container houses 1 are placed in multiple stages of the mega structure to complete the mega structure assembly with the mega structure framework according to this example.

A framework is formed by the pillar members 105 and the beam members 107 in the structure 101 at the installation site 100 for installing the container house assembly 1. Furthermore, a framework of a staircase portion is formed adjacent to the structure 101 by the pillar members 113 and the beam members 114 in the staircase structure part 103. After the frameworks are formed by the pillar members 105 and 113 and the beam members 107 and 114, the floors 108 are placed on the beam members 107 to form the spaces 106 capable of housing the movable prefabricated container houses 1 therein.

Thereafter, the movable prefabricated container houses 1 are housed in the spaces 106 formed between the beam members 107 by use of a mobile crane or the like straddling two horizontally facing mega structures and fixed by un-illustrated fixing means. In this case, the movable prefabricated container houses 1 are placed at positions leaving the corridor forming parts 112 continuous with the staircase structure part 103. By housing and fixing the movable prefabricated container houses 1 in the spaces 106 formed in multiple stages by the beam members 107, the container house assembly having the movable prefabricated container houses 1 stacked in multiple stages is formed. Subsequently, the side surfaces of the structure 101 are finally covered with the protection nets 116.

As described above, according to this example, more living spaces can be provided by installing the movable prefabricated container houses 1 in multiple stages to form a mega structure even at a site having a small and limited installation area.

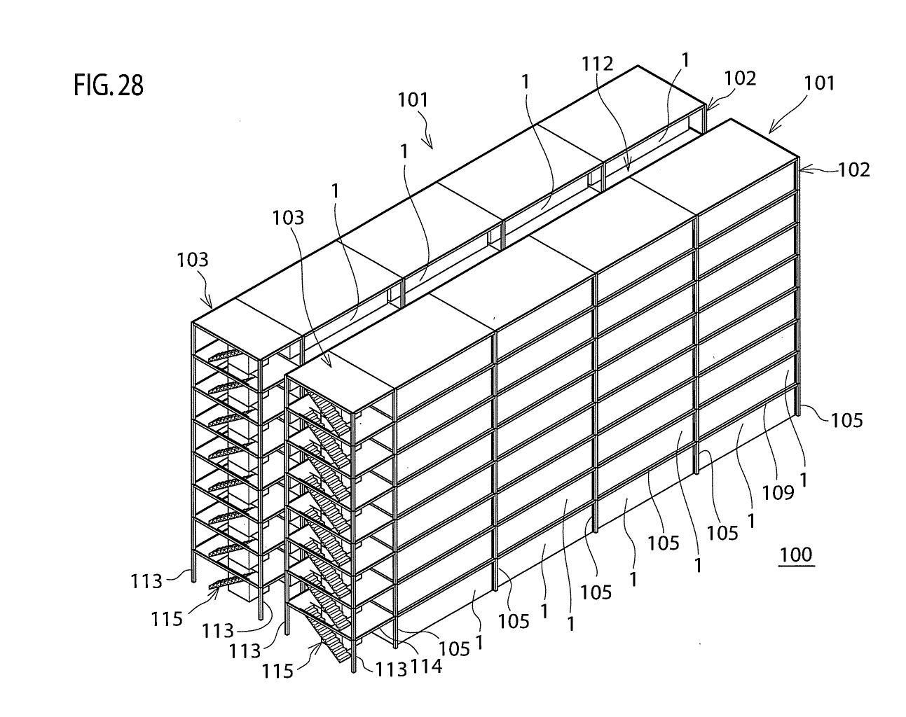

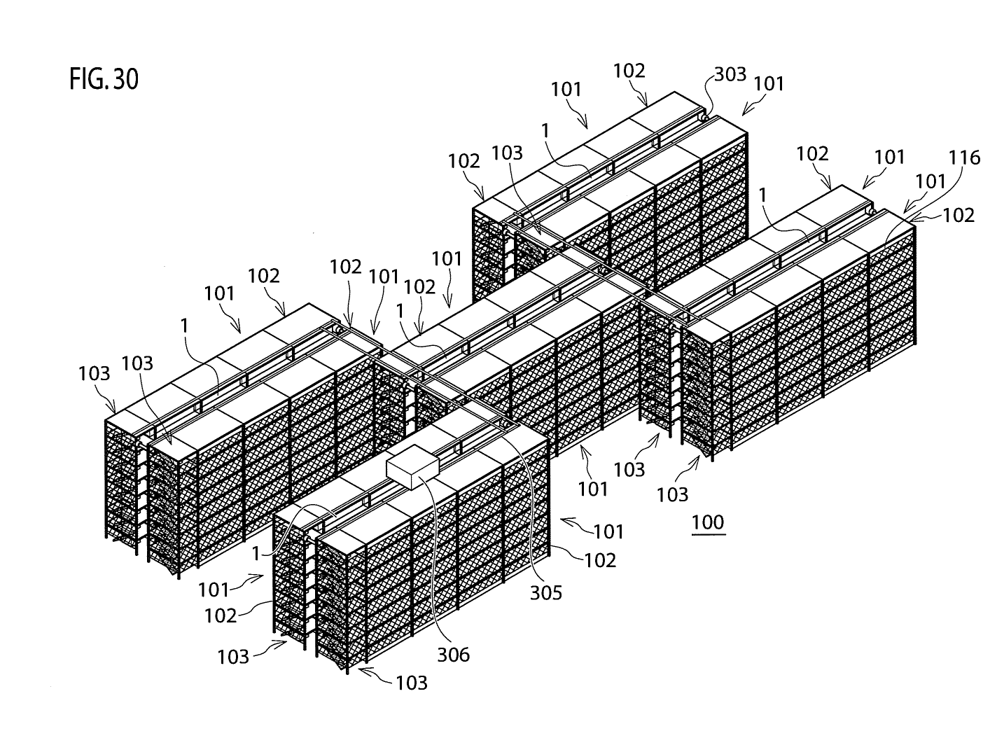

Moreover, as shown in FIGS. 28 and 30, more living spaces can be provided by forming the plurality of mega structures having the movable prefabricated container houses 1 stacked in multiple stages at the installation site. In this case, as shown in FIG. 30, by partially connecting the container house assemblies to each other, the mega structures can be connected to each other ad infinitum enabling a single crane to travel between the mega structures, hoisting and lowering the movable prefabricated container houses as needed. FIG. 30 shows a state where a plurality of mega structures are in assembly, the juxtaposition of mega structures provides space for installation of hundred and thousands of container houses. Tracks 305 are laid down along the edges of the mega structures and a crane 306 is displayed which will move on the tracks from one mega structure to another. Dampers 303 connecting the mega structures are also displayed between the upper ends of each mega structure.

### Example 6

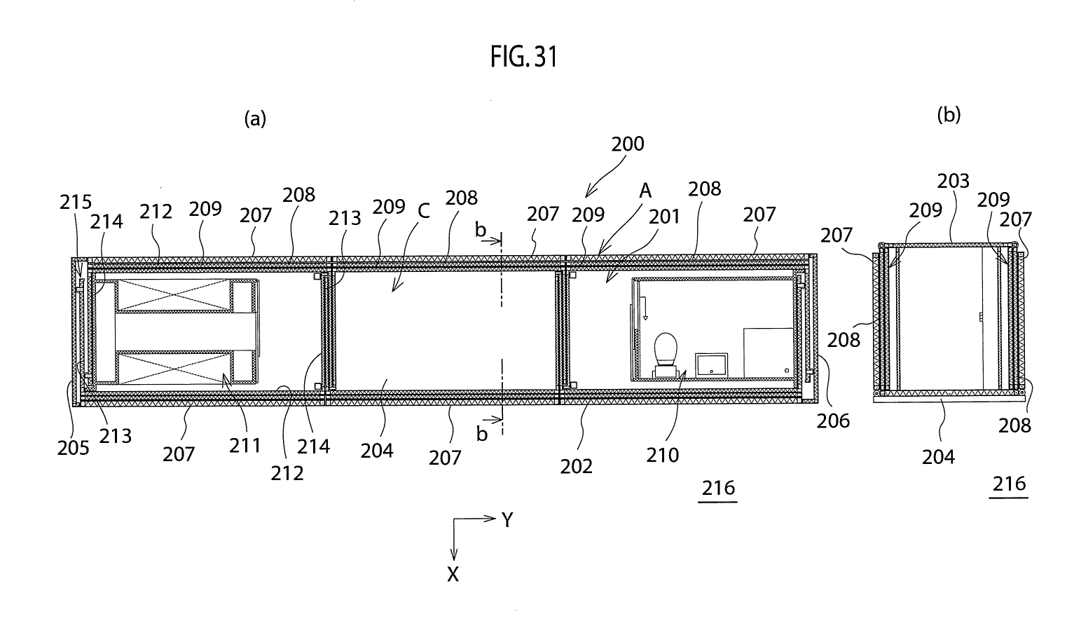

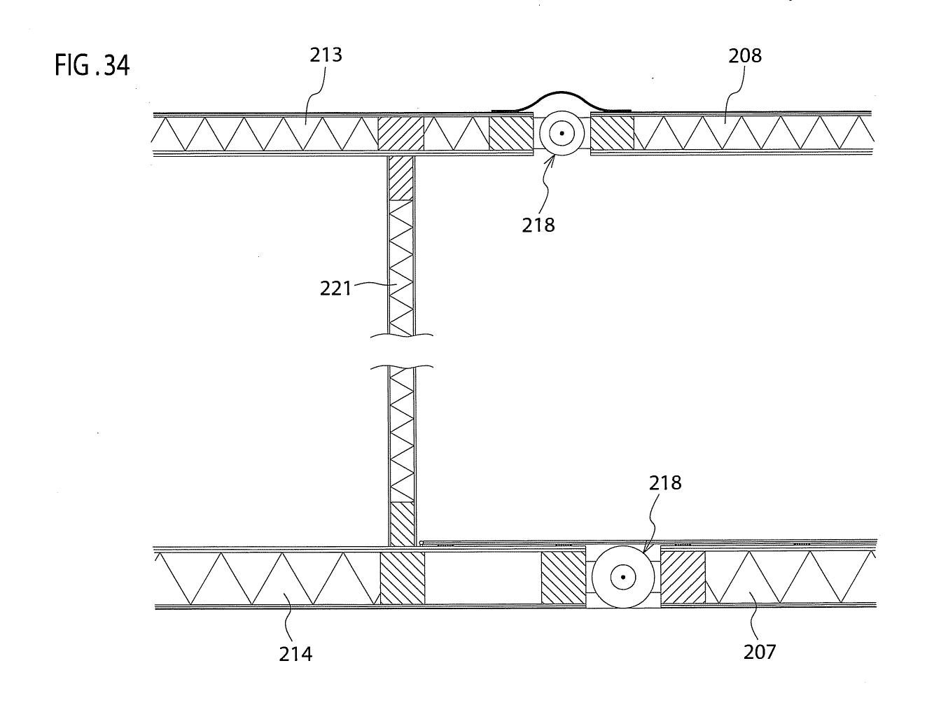

Next, with reference to FIGS. 31 to 40, an example 6 of the movable prefabricated container house will be described. In the following description, only portions different from the movable prefabricated container house 1 of the example 1 will be described.

As in the case of the example 1, a movable prefabricated container house 200 of this example includes: a main body A transportable/movable to an installation site 216; and a house formed by pre-assembled square “U”-shaped walls. The square “U”-shaped or “U”-shape walls are configured to be housed in the main body A, transported/moved to the installation site along with the main body A, and drawn out of the main body A at the installation site and expanded/assembled so that the pre-assembled square “U”-shaped walls are sandwiched between the ceiling and floor boards. The main body A includes a container-shaped main frame member 201 capable of being pulled by a trailer truck 2 as in the case of the example 1. The house formed with pre-assembled square “U”-shape walls includes a plurality of dwelling forming members 202 which can be housed in the main frame member 201 and which can be drawn out of the main frame member 201 at the installation site and assembled into a house.

As shown in FIGS. 31, 32 and 36 to 40, the main frame member 201 is formed into a box shape by a pair of upper and lower horizontal frames 203 and 204 forming a floor and a ceiling, respectively, and a pair of vertical frames 205 and 206 connecting the horizontal frames at the ends of the horizontal frames to form a wall. The dwelling forming members 202 include a floorboard 207, a ceiling board 208, wall panels 209, a bath/toilet unit 210 and a bed unit 211.

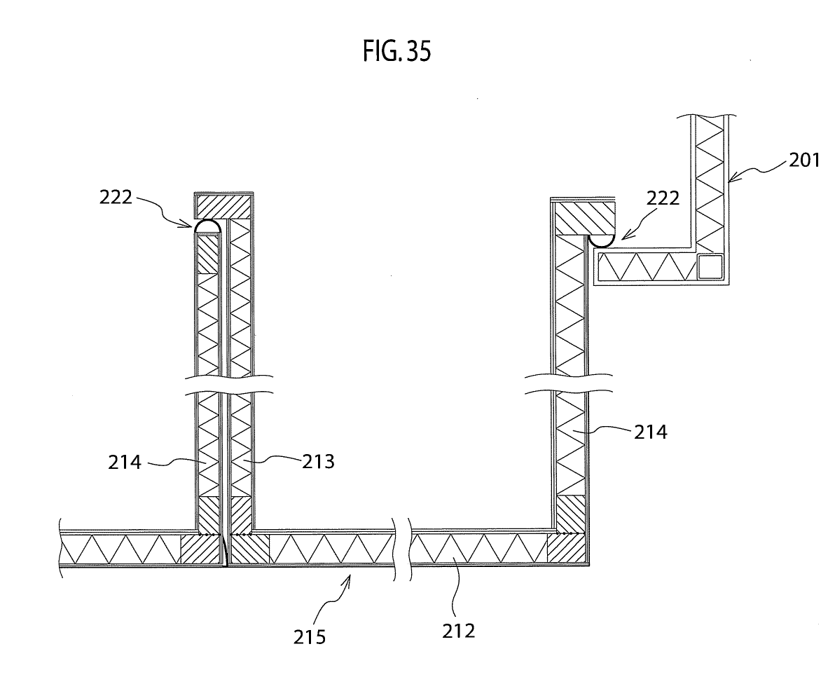

Each of the wall panels 209 is formed of a unit wall 215 having first to third wall panels 212, 213, and 214 previously formed in a pre-assembled square “U”-shape in a planar view, and is housed in the main frame member 201 while maintaining the square “U”-shape (see FIG. 35). After the movable prefabricated container house 200 is placed at the predetermined installation site 216, the wall panel 209 is drawn out of the main frame member 201 as the unit wall 215 while maintaining the square “U”-shape and serves as walls on three sides except the floor board 207 and the ceiling board 208. Thus, the wall panel 209 forms a living space together with the floor board 207 and the ceiling board 208.

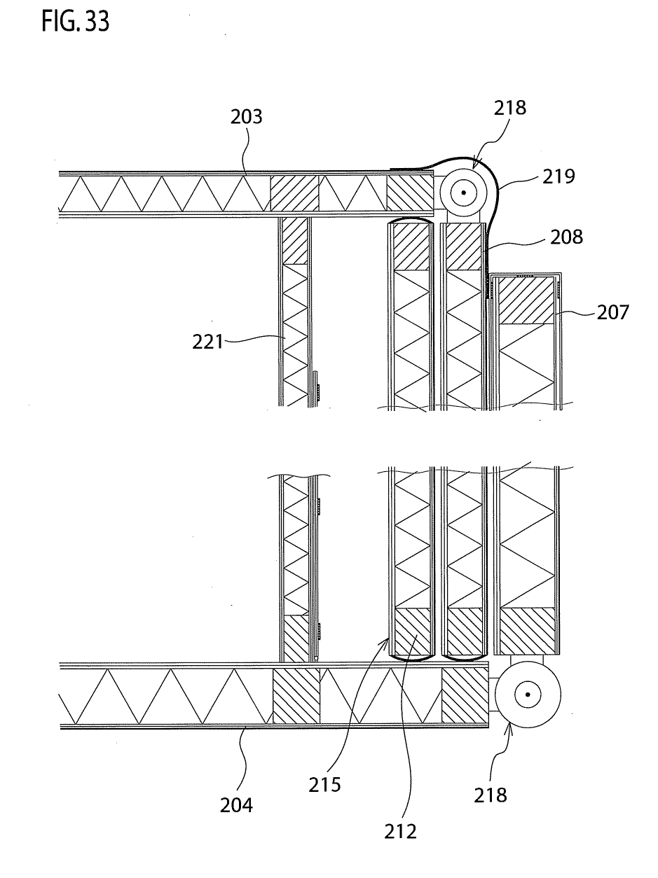

Moreover, the main frame member 201 houses a supporting frame 217 which is drawn out of the main frame member 201 at the installation site 216 and supports the floor board 207. As shown in FIG. 33, the floor board 207 is rotatably supported by a rotating part 218 on the lower horizontal frame 204 of the main frame member 201, and is expanded on the supporting frame 217 at the time of assembly. Moreover, the ceiling board 208 is also rotatably supported by the rotating part 218 on the upper horizontal frame 203 of the main frame member 201 as in the case of the floor board 207, and is expanded on the unit wall 215 at the time of assembly. Thus, although a frame supporting the ceiling board 208 is required in the example 1, such a frame is no longer required in this example. Specifically, in this example, the ceiling board 208 is temporarily held by a rod member 213 or supporting column 223 or the like in a state of being rotated and expanded with respect to the horizontal frame 203. Thereafter, the ceiling board 208 is mounted on and fixed to an end portion of the unit wall 215 after drawing out the unit wall 215. Thus, the frame supporting the ceiling board 208 is no longer required. Note that a cover 219 is provided outside the rotating part 218 rotatably connecting the ceiling board 208 to the horizontal frame 203.

Moreover, as the unit walls 215, one side unit wall 215 drawn out to one side of the main frame member 201 and the other side unit wall 215 drawn out to the other side of the main frame member 201 are provided. The one side unit wall 215 and the other side unit wall 215 are housed in the main frame member 201 while having the second and third wall panels 213 and 214 overlap with each other as shown in FIG. 31. Specifically, the other side unit wall 215 is housed in the main frame member 201 in a state of being shifted in a longitudinal direction (Y-axis direction) of the main frame member 201 with respect to the one side unit wall 215.

Moreover, in a state where the one side unit wall 215 and the other side unit wall 215 are drawn out, as shown in FIG. 35, the second wall panel 213 comes into contact with a rubber-like stopper part 222 formed at an end of the third wall panel 214 of the adjacent unit wall 215, and a rubber-like stopper part 222 formed at an end of the third wall panel 214 comes into contact with the main frame member 201. Thus, a draw-out position of the unit wall 215 is determined.

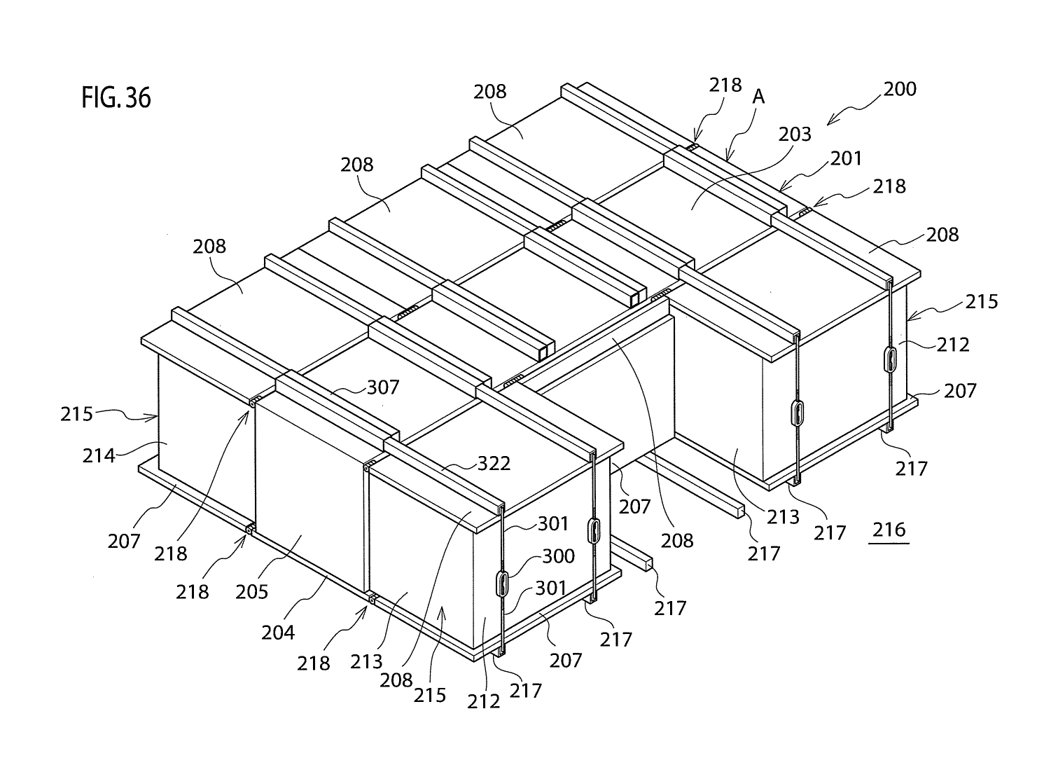

Next, with reference to FIGS. 36 to 40, description will be given of procedures for installing the movable prefabricated container house 200 at the installation site 216 after moving the movable prefabricated container house 200 to the installation site 216.

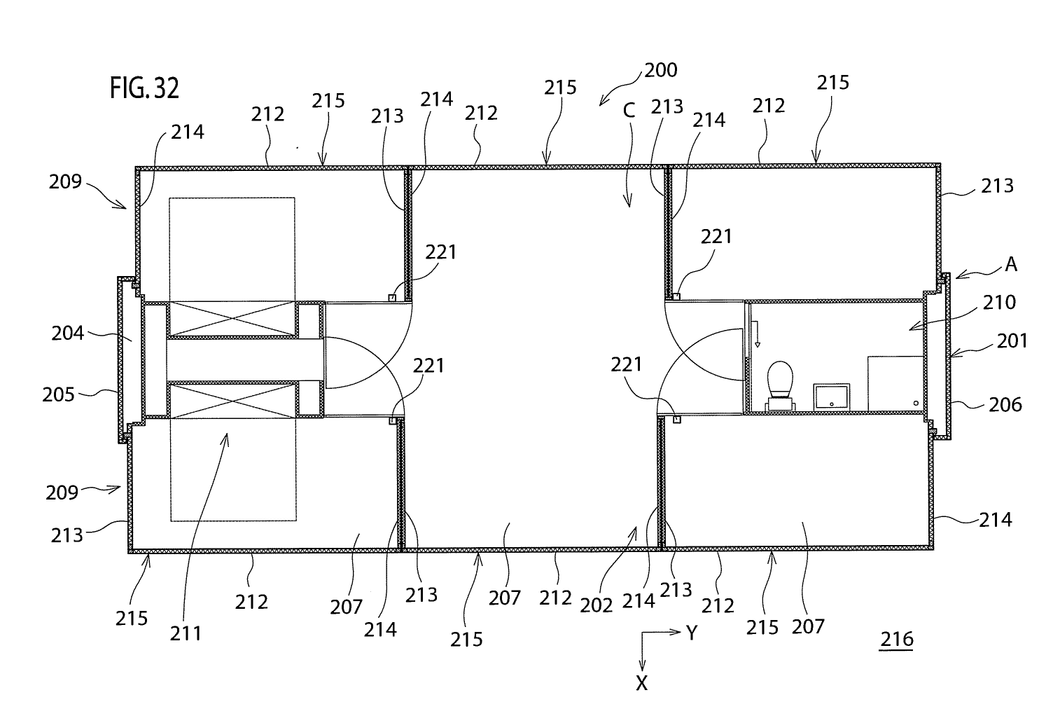

As shown in FIGS. 36 to 39, the supporting frame 217 is drawn out of the lower side of the horizontal frame 204 in a state where the movable prefabricated container house 200 is placed at the installation site 216. From this state, the floor board 207 is rotated by the rotating part 218 and then mounted and fixed onto the supporting frame 217. Next, in a state where the ceiling board 208 is rotated by the rotating part 218 and positioned at a ceiling portion by a rod member or supporting column (not shown), the unit wall 215 is drawn out between the floor board 207 and the ceiling board 208 as shown in FIGS. 36 to 39. The unit wall 215 is drawn out to a fully extended position where the draw-out position thereof may be determined by a stopper part (not shown). In this state, the rod member is removed and the unit pre-assembled square “U”-shape wall 215 is fixed to the floor board 207 and the ceiling board 208. As in the case of the one side unit wall 215, the other side unit wall 215 is also drawn out of the main frame member 201 through the above procedures. In this example, the three unit pre-assembled square “U”-shape walls 215 are drawn out to the both sides of the main frame member 201, respectively. Thus, six rooms can be formed as shown in FIG. 32.

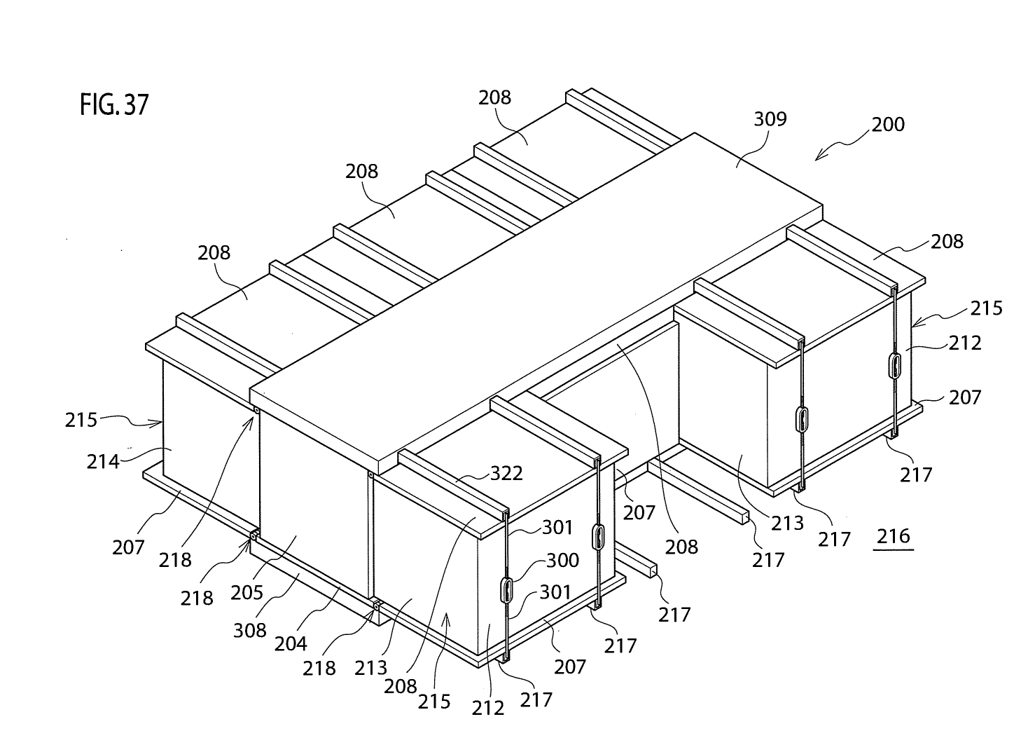

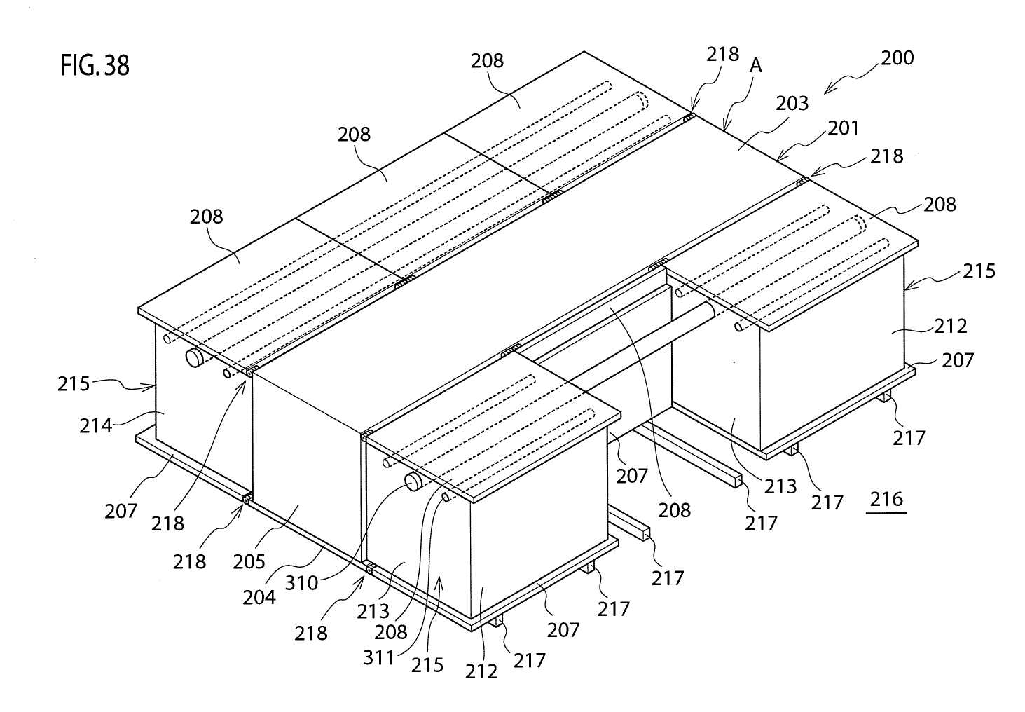

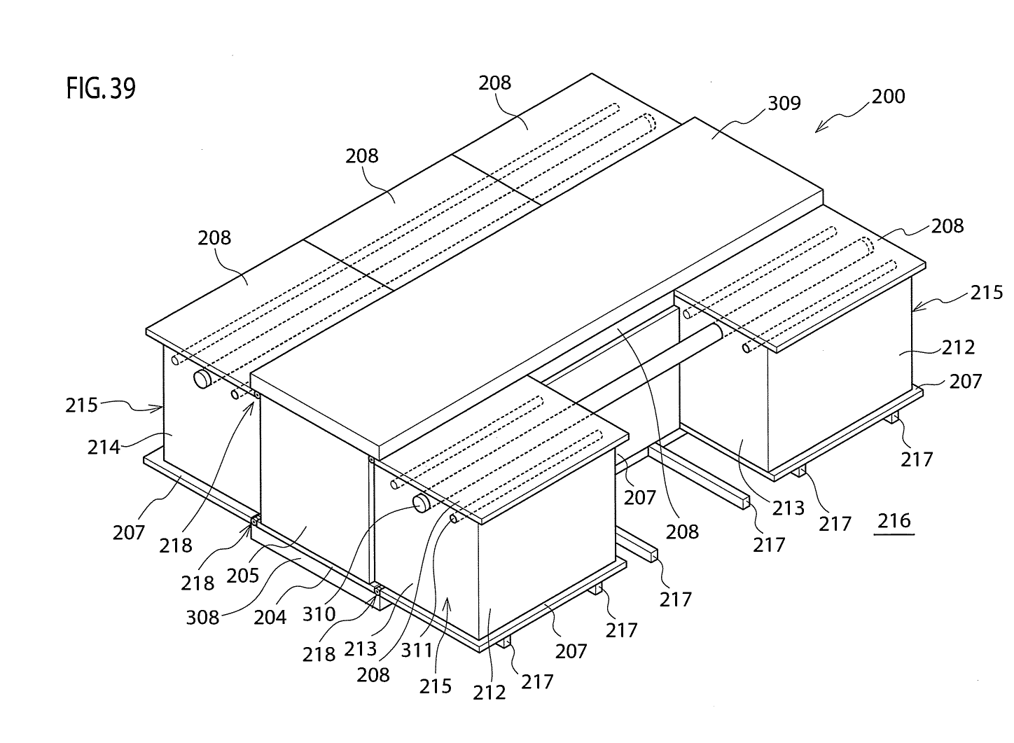

An supporting frame extension 322 may be drawn out of an upper supporting frame 307 on the upper side of the horizontal frame 203 to further support the ceiling board 208 as shown in FIGS. 36 and 37. Optionally, an extended floor 308 and ceiling 309 (covering upper supporting frame(s) 307), shown in FIGS. 37 and 39 may be used to add additional support to the houses 200 shown in FIGS. 36 and 38.

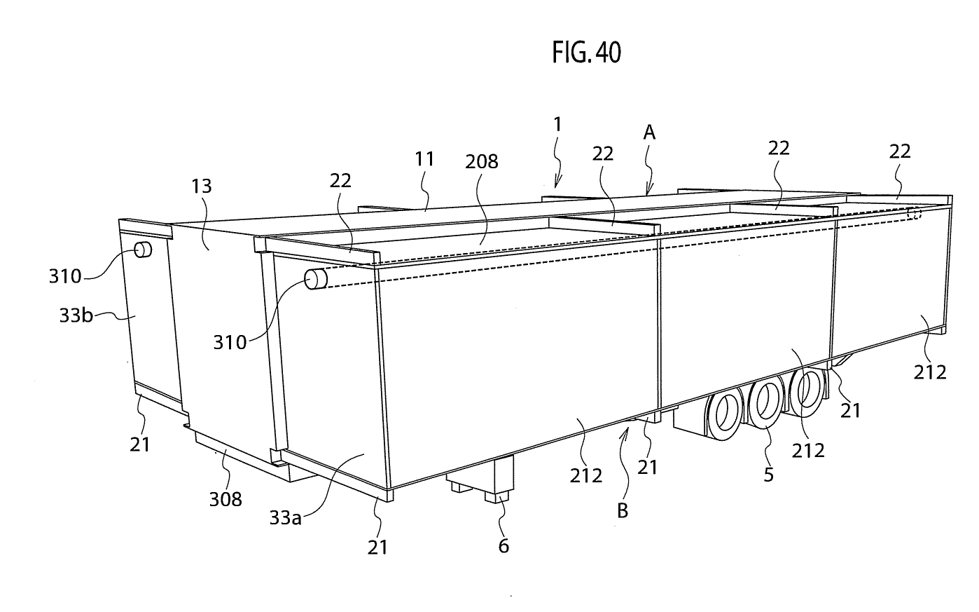

Accordingly, as shown in FIGS. 32 and 40, a house section can be extended and a living space can be extended.

In this example, the three walls except the floor board 207 and the ceiling board 208 are previously formed, i.e. pre-assembled in the square “U”-shape, housed in the main frame member 201 and then drawn or pulled out while maintaining the square “U”-shape. Thus, operations of individually connecting and fixing the first to third wall panels 212 to 214 are no longer required. As a result, expansion and assembly of the house can be more easily performed than in the example 1. In addition, this design renders the walls resistant to earthquake and hurricane when combined with a process wherein the ceiling beams and floor beams are tied together with cables 301 and tightened with clamps or shackles 300, as shown in FIGS. 36 and 37, or steel rods or pipes 310 are inserted perpendicularly, i.e. horizontally to the main frame, between the walls to reinforce or hold the walls together, as shown in FIGS. 38-40. In one embodiment, the steel rods or pipes 311 reinforcing the “U”shape wall can have a smaller diameter than the steel rods or pipes 310 reinforcing the “U”-shape walls throughout the length of the house.

Moreover, in this example, as in the case of the above examples, the container-shaped main frame member 201 serves as an outer shell of the house. Thus, the movable prefabricated container house can be used as a house. Therefore, troublesome assembly at a destination can be reduced to take only three hours of labor time by three persons. Moreover, since the main frame member 201 can be pulled by a trailer, the container house can be moved to any site and re-used any number of times.

Furthermore, the dwelling forming members 202 housed in the main frame member 201 can be easily drawn out and assembled. Thus, a plurality of living spaces and bedrooms can be formed by being drawn out to the left and right of the main frame member 201.

Note that windows and doorways may be previously formed in the first to third wall panels forming the unit wall 215.

### Example 7

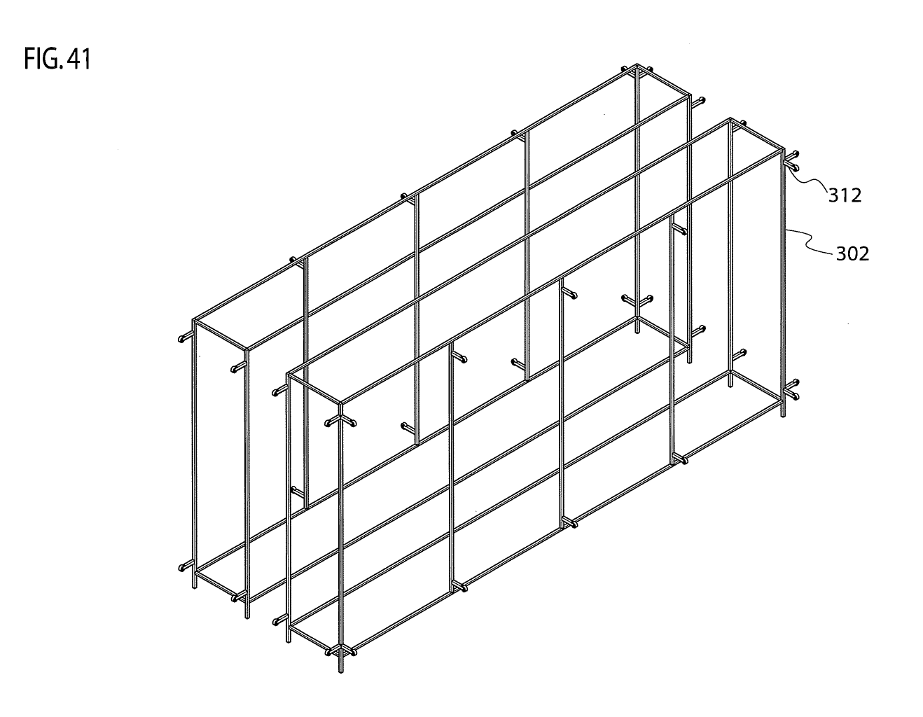

Next, with reference to FIGS. 41 to 45, description will be given of an example 7 in the case where two sets of frames are used to form mega structures.

In example 7 a mega structure assembly having a plurality of the movable prefabricated container houses 1 described above is installed in a limited site. The mega structure can be formed by installing the movable prefabricated container houses 1 in a position facing each other horizontally with a crane straddling the two structures at the top of the structures on tracks laid along the inner edges of structures.

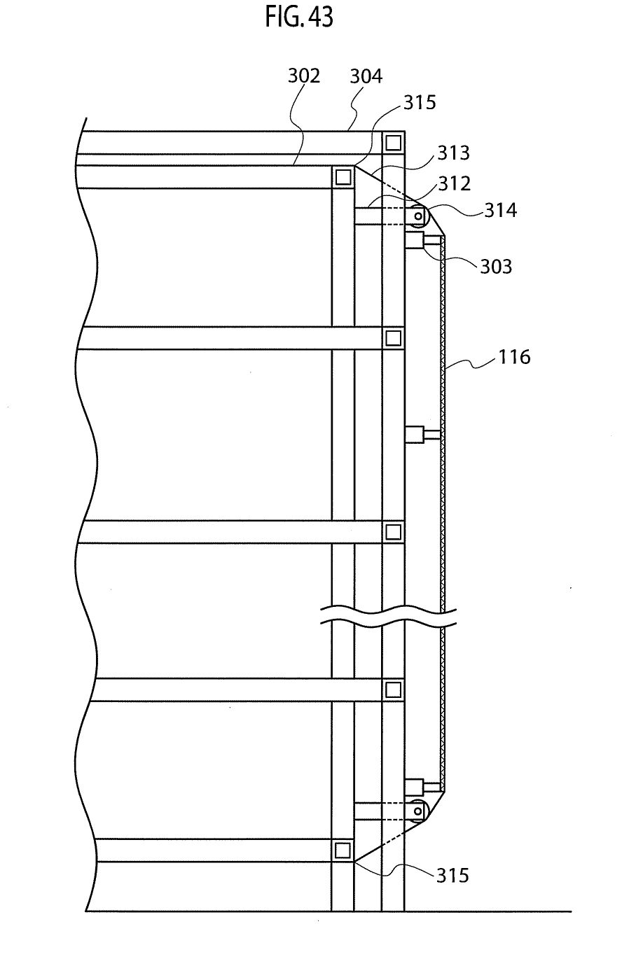

As shown in FIG. 41, two sets of inside frames 302 support a wire mesh (see FIG. 43) which will provide earthquake- and hurricane-resistant support to the outside frames. Attention is drawn to the small beams 312 protruding from the main frames along which the main cables supporting the wire mesh (see FIG. 43) will travel.

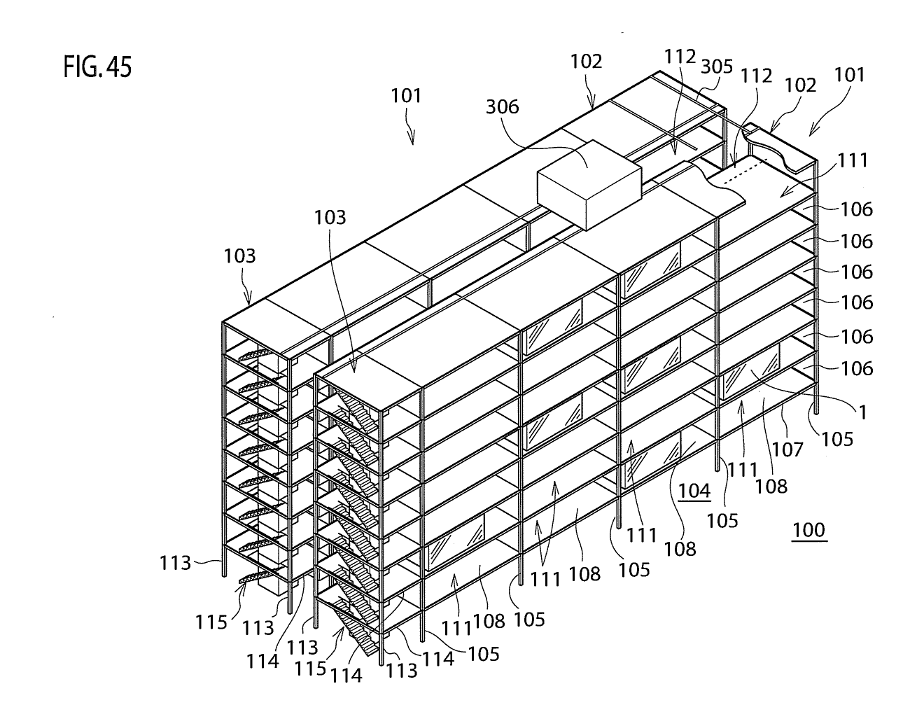

As shown in FIGS. 42 and 45, the movable prefabricated container houses 1 according to this example are built into mega structures 101 formed at an installation site 100 and are placed three or more stories high. Each of the mega structures 101 includes a housing structure part 102 for housing the container houses 1 and a staircase structure part 103 placed adjacent to the housing structure part 102.

The housing structure part 102 includes: a plurality of pillar members 105 provided upright from the ground 104; beam members 107 connecting the pillar members 105 and defining spaces 106 for housing the containers 1 with the pillar members 105 assembled into a grid-like structure; and floors or floorboards 108 on which the container houses 1 housed in the spaces 106 are mounted, the floorboards 108 being supported by the beam members 107.

The beam members 107 include: framework beam members 109 forming a framework together with the pillar members 105; and container supporting beam members 110 connected between the framework beam members 109 and supporting the floors 108. Each of the floors 108 includes: a container mounting part 111 on which the movable prefabricated container house 1 is mounted; and a corridor forming part 112 adjacent to the container mounting part 111. This corridor forming part 112 is connected to the staircase structure part 103. Thus, it is possible to go to the corridor forming part 112 at each stage through the staircase structure part 103.

The staircase structure part 103 includes pillar members 113, beam members 114 and staircase units 115 provided in spaces defined by the pillar members 113 and the beam members 114.

Next, description will be given of procedures by which the movable prefabricated container houses 1 are placed in multiple stages of the mega structure to form the mega structure assembly according to this example.

A framework is formed by the pillar members 105 and the beam members 107 in the structure 101 at the installation site 100 for installing the container house assembly 1. Furthermore, a framework of a staircase portion is formed adjacent to the structure 101 by the pillar members 113 and the beam members 114 in the staircase structure part 103. After the frameworks are formed by the pillar members 105 and 113 and the beam members 107 and 114, the floors 108 are placed on the beam members 107 to form the spaces 106 capable of housing the movable prefabricated container houses 1 therein.

Thereafter, the movable prefabricated container houses 1 are housed in the spaces 106 formed between the beam members 107 by use of a mobile crane or the like straddling two horizontally facing mega structures and fixed by un-illustrated fixing means. In this case, the movable prefabricated container houses 1 are placed at positions leaving the corridor forming parts 112 continuous with the staircase structure part 103. By housing and fixing the movable prefabricated container houses 1 in the spaces 106 formed in multiple stages by the beam members 107, the container house assembly having the movable prefabricated container houses 1 stacked in multiple stages is formed. Subsequently, the side surfaces of the structure 101 are finally covered with the protection nets 116.

FIG. 42 is a perspective view of four sets of frames. The inside set of (two) frames 302 supports the wire mesh while the outside set of (two) frames 304 supports the floors on which the container houses will be placed and anchored.

FIG. 43 is a close-up view of the side of a mega structure made of inside 302 and outside frames 304. The smaller inside frame has two beams 312 protruding from it at the top and at the bottom, each with rollers 314. The larger outside frame has dampers 303 protruding from it at three places: near the top, near the midpoint, and near the bottom.

A cable 313 is attached to the top of the smaller inside frame 302 and stretches around the roller 314 attached to the beam 312 protruding from the frame. The cable 313 supports a wire mesh 116 which travels along the side of the larger outside frame 304 and pushes against the (three) dampers 303, until the bottom end of the cable 313 travels around the bottom most roller 314 of the smaller frame 302 and is attached to the smaller inside frame at an attachment point 315.

As described above, according to this example, more living spaces can be provided by installing the movable prefabricated container houses 1 in multiple stages to form a mega structure even at a site having a small and limited installation area.

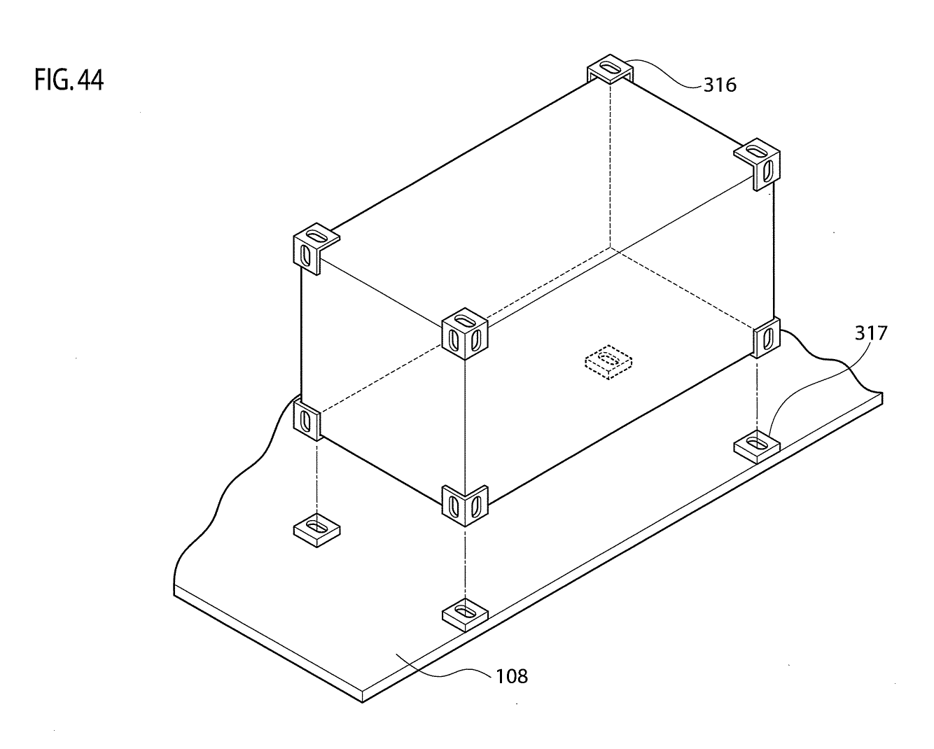

Moreover, as shown in FIGS. 44 and 45, more living space can be provided by forming the plurality of mega structures having the movable prefabricated container houses 1 stacked in multiple stages at the installation site. In this case, as shown in FIG. 45, by connecting the container house assemblies to each other using a connection mechanism (for example, four brackets 316 for the container house to be mounted and secured with twist-locks [not shown] against similarly configured mating brackets 317) shown in close-up view in FIG. 44 of the floor 108 of a mega structure, more living space is provided. The mega structures can be connected to each other ad infinitum enabling a single crane 306 to travel between the mega structures on tracks 305, hoisting and lowering the movable prefabricated container houses 1 as needed.

### INDUSTRIAL APPLICABILITY

This invention can provide a prefabricated container house which can be moved to any place, which enables the amount of cumbersome assembly work to be minimal and which enables living space to be extended nearly threefold based on a single unit, and with its process to safeguard the house against earthquake and hurricane, enables the house to exist for a long time. And if there is a need to relocate the houses, to do it just as easily by reversing the assembly process, and accomplishing the move without leaving any debris behind, making the house re-useable for a long time. Ultimately the house will have to be melted down and recycled.

1. A prefabricated container house comprising:
a main body transportable/movable to an installation site; and
a house forming body configured to be housed in the main body, transported/moved to the installation site along with the main body, and drawn out of the main body at the installation site so as to be expanded/assembled,
wherein in an expanded/assembled state the house further comprises wires/cables and shackles configured for structural support against earthquakes and hurricanes.

2. The prefabricated container house according to claim 1, wherein
the main body comprises a container-shaped main frame member capable of being pulled by a trailer truck, and
the house forming body comprises a plurality of dwelling forming members, the dwelling forming members being capable of being housed in the main frame member, drawn out of the main frame member at the installation site, and assembled into a house.

3. The prefabricated container house according to claim 2, wherein
the main frame member is formed into a box shape with a pair of upper and lower horizontal frames forming a floor and a ceiling, respectively, and with a pair of vertical frames each connecting the horizontal frames at ends of the horizontal frames to form a wall,
the dwelling forming members comprise a floorboard, a ceiling board, two designs of wall panels, a bath/toilet unit, and a kitchen unit,
the main frame member houses a sub-frame member comprising a floor supporting frame/beam supporting the floor board which is drawn out of the main frame member and assembled at the installation site, and a ceiling supporting frame/beam supporting the ceiling board which is drawn out of the main frame member and assembled at the installation site,
wherein at least one shackled wire/cable connects at least one of a pair of ceiling and floor supporting frames/beams.

4. The prefabricated container house according to claim 3, wherein the sub-frame member comprises reinforcing columns provided between the pair of horizontal frames so as to reinforce the main frame member.

5. The prefabricated container house according to claim 3, wherein the floor supporting frame/beam and the ceiling supporting frame/beam are drawn outward from the horizontal frames.

6. The prefabricated container house according to claim 1, wherein two or more of the house bodies are stacked to form a multi-story dwelling.

7. The prefabricated container house according to claim 3, wherein
the floor board and the ceiling board are overlapped and housed between the pair of horizontal frames,
at least one of the wall panels is overlapped with a corresponding one of the vertical frames and housed, and
the rest of the wall panels are overlapped and housed at an intermediate position between the vertical frames.

8. A container house comprising:
a main frame member having a box shape and an opening on at least one of sides of the main frame member, the main frame member comprising a pair of vertical frames having a rectangular plate shape, and upper and lower horizontal frames each having a rectangular plate shape connected to the pair of vertical frames;
a movable floor board configured to horizontally extend from a lower portion of the main frame member outward of the main frame member;
a movable ceiling board configured to horizontally extend from an upper portion of the main frame member outward of the main frame member;
movable wall panels configured to be drawn out of one of the vertical frames between the movable floor board and the movable ceiling board; and
wires/cables and shackles configured for structural support against earthquakes and hurricanes,
wherein the movable floor board and the movable ceiling board are extended horizontally.

9. The container house according to claim 8, wherein
the movable floor board is supported on the lower portion of the main frame member pivotally between a vertical position and a horizontal position about a horizontal axis,
the movable floor board functions as a cover closing the opening of the main frame member in the horizontal position.

10. The container house according to claim 8, wherein the movable ceiling board is supported on the upper portion of the main frame member pivotally about a horizontal axis.

11. The container house according to claim 8, wherein the respective movable wall panels include an outer wall panel supported on an end of the respective movable wall panels pivotally about a vertical axis.

12. The container house according to claim 8, further comprising a floor supporting frame/beam protrudable under the movable floor board from a lower portion of the main frame member so as to support the movable floor board extended horizontally,
wherein the floor supporting frame/beam is connected to at least one shackled wire/cable.

13. The container house according to claim 8, further comprising a ceiling supporting frame/beam protrudable over the movable ceiling board from an upper portion of the main frame member so as to support the movable ceiling board extended horizontally,
wherein the ceiling supporting frame/beam is connected to at least one shackled wire/cable.

14. The container house according to claim 8, further comprising a bed unit supported on a lower portion of the main frame member pivotally in a horizontal axis.

15. The container house according to claim 8, wherein the movable wall panels are provided slidably on the movable floor board.

16. The container house according to claim 8, wherein
the movable ceiling board is supported on the upper portion of the main frame member pivotally between a vertical position and a horizontal position in a horizontal axis, and
the movable ceiling board functions as a cover closing the opening of the main frame member in the horizontal position.

17. A container house, comprising:
a main frame member having a box shape and an opening on at least one of sides of the main frame member, the main frame member comprising a pair of vertical frames having a rectangular plate shape, and upper and lower horizontal frames each having a rectangular plate shape connected to the pair of vertical frames;
a movable floor board configured to horizontally extend from a lower portion of the main frame member outward of the main frame member, the movable floor board being supported on the lower portion of the main frame member pivotally between a vertical position and a horizontal position about a horizontal axis, and the movable floor board functioning as a cover closing the opening of the main frame member in the horizontal position;
a movable ceiling board configured to horizontally extend from an upper portion of the main frame member outward of the main frame member, the movable ceiling board being supported on the upper portion of the main frame member pivotally on a horizontal axis;
movable wall panels configured to be drawn out of one of the vertical frames between the movable floor board and the movable ceiling board, with the movable floor board and the movable ceiling board extended horizontally, the movable wall panels being provided slidably on the movable floor board, the movable wall panels including outer wall panels each supported at one end of the movable wall panels pivotally in a vertical axis;
a floor supporting frame/beam protrudable under the movable floorboard from a lower portion of the main frame member so as to support the movable floor board extended horizontally;
a ceiling supporting frame/beam protrudable over the movable ceiling board from an upper portion of the main frame member so as to support the movable ceiling board extended horizontally; and
wires/cables and shackles configured for structural support against earthquakes and hurricanes,
wherein at least one shackled wire/cable connects at least one of a pair of ceiling and floor supporting frames/beams.

18. The prefabricated container house according to claim 2, further comprising:
an installation foundation body installed at the installation site and having the prefabricated container house mounted thereon,
wherein the installation foundation body comprises
a buried pipe body buried in the ground,
a pole body provided upright in the buried pipe body in a state where a tip portion of the pole body protrudes from the ground, and
dampers welded to the pole body, a first set of dampers welded perpendicular to the pole body and a second set of dampers welded at the bottom of the pole body in an approximately 45 degree angle in the buried pipe body to support the pole body in the buried pipe body in order to render the house with the foundation resistant to earthquakes and hurricanes.

19. The prefabricated container house according to claim 18, wherein
the buried pipe body comprises:
a peripheral wall part having a hollow inside with a steel ring welded to the bottom end of the pipe body inside the pipe body,
a cover part/lid connected to the peripheral wall part through a rotating part/hinge at the lower end of the peripheral wall part and capable of opening and closing at the lower side opening of the peripheral wall part, and
an upper stationary cover body provided at an upper end of the peripheral wall part having a rubberized O-ring in the underside of the cover body to render the pipe body and the inside of the peripheral wall part air-tight as well as enabling the pole body to be cushioned against it in the event of an earthquake and/or hurricane; and
the pole body comprises:
a rod-shaped pole main body having a mounting surface formed at the tip portion of the rod-shaped pole main body, the prefabricated container house being mounted on the mounting surface, and
a pole supporting member that supports the pole main body inside the buried pipe body, the pole supporting member comprising dampers welded to the pole in two places, a first set of dampers welded perpendicular to the pole, and a second set of dampers welded at the bottom of the pole at approximately 45 degree angle.

20. The prefabricated container house according to claim 19, wherein
the pole supporting member comprises a ring-shaped connection part fixed to a periphery of the pole main body and two sets of dampers welded to the connection part, the first set of dampers welded perpendicular from the pole main body and the second set of dampers welded at the bottom of the pole main body in an approximately 45 degree angle and the other end supported by an inner wall of the peripheral wall part.

21. The prefabricated container house according to claim 19, wherein
after recovering the movable prefabricated container house from the installation site, the buried pipe body is drawn out of the ground together with the pole body, and the lower movable cover body/lid is rotated around the rotating part/hinge.

22. The prefabricated container house according to claim 2, wherein
the main frame member is formed into a box shape with a pair of upper and lower horizontal frames forming a floor and a ceiling, and with a pair of vertical frames each connecting the horizontal frames at ends of the horizontal frames to form a pre-assembled square “U”-shape wall,
each dwelling forming member comprises:
floor boards;
ceiling boards;
wall panels;
bath/toilet units; and
a kitchen unit,
each wall panel comprises pre-assembled square “U”-shape unit walls comprising three unit wall panels, pre-assembled or formed into a square “U”-shape in a planar view sandwiched between the floor and ceiling boards,
the main frame member comprises a supporting frame/beam which is drawn out of the main frame member at the installation site to support the floor board, with the floor board rotatably supported on the lower horizontal frame of the main frame member and expanded onto the supporting frame at the time of assembly,
the ceiling board is rotatably supported by the upper horizontal frame/beam extended from the main frame member at the time of assembly, and
at least one shackled wire/cable connects at least one of a pair of ceiling and floor supporting frames/beams.

23. A prefabricated container house configured for installation in urban environments and placement in a plurality of mega structures, wherein the prefabricated container house is capable of being
hoisted by a crane to a floor where the house is to be situated,
taken by one or more forklifts from the crane and positioned on the floor where the house is to be situated, and
locked in place to arrangements on the floor for securing the houses with devices such as twist-locks,
wherein the container house comprises wires/cables and shackles configured for structural support against earthquakes and hurricanes.

24. A mega structure comprising:
two identical steel structures positioned to face each other horizontally at a distance that is the same as the width of a traveling crane; and
a plurality of floors with at least one arrangement on each floor for securing one or more prefabricated container houses configured for installation in urban environments and placement on mega structure floors with devices such as twist-locks,
wherein at least one container house comprises wires/cables and shackles configured for structural support against earthquakes and hurricanes.

25. Sets of mega structures comprising two or more of the mega structure of claim 24, wherein
the steel structures are juxtaposed and connected with tracks enabling a single crane to move from any of one set of identical mega structures to another set, wherein
the crane is placed on top of the two structures, straddling the structures on tracks laid along the edges of each structure,
the crane will hoist or lower each prefabricated container house to or from the floors in the mega structure, and
one or more forklifts will take each house from the crane and position it on the floor where the house is to be situated, locking the house in place to arrangements on the floor for securing the house with devices such as twist-locks.

26. The arrangement of many sets of mega structures of claim 25, enabling connection of several sets of mega structures together ad infinitum, and thereby to place countless prefabricated container houses in a relatively small space in an urban setting.

27. The mega structure of claim 24, wherein the mega structure is draped with wire mesh to protect the mega structure against earthquakes and hurricanes.

28. The mega structure of claim 24, wherein the wire mesh further comprises dampers connecting it to the mega structure in several places, thereby protecting the mega structure from earthquakes and hurricanes.

29. The mega structure of claim 24, wherein the structure further comprises stairwells containing sets of stairs and elevators for people to ascend and descend the mega structure and for machinery such as forklifts to be delivered or removed from the floors.

30. A method of building a house with standard container frames comprising:
taking the frame of a standard container;
assembling the container into a house;
reinforcing the container with wires/cables and shackles for structural support against earthquakes and hurricanes and
situating a house at a desired location.

31. A method of transporting a not yet assembled (pre-assembly) container house, the method comprising:
1) shipping the container house by container ship from factory to port destination, and/or transporting by rail and/or by tractor-trailer to the place of installation;
2) lifting the container house on and then off a container ship and/or railcar and/or tractor-trailer by crane or forklift;
3) placing the container house onto four cylindrical foundations designed for the container house;
4) reinforcing the container with wires/cables and shackles for structural support against earthquakes and hurricanes; and
5) locking the house to the foundation with twist-locks.

32. A method of preparing a foundation for the placement of a container house reinforced with wires/cables and shackles for structural support against earthquakes and hurricanes, the method comprising:
delivering cylindrical foundations to the construction site either by sea and/or land;
boring four holes into the ground where the house reinforced with wires/cables and shackles for structural support against earthquakes and hurricanes is to be situated; and
inserting the cylindrical foundation into each hole.

33. The method of claim 30 of building a house with standard container frames, wherein the standard container frame has one or more embodiments built within the frame or attached to the frame selected from the group consisting of: ceiling/roof beams in the top 40 feet sides of the frame, floor beams in the bottom 40 feet sides of the frame, ceiling/floor boards against the 40 feet sides of the frame, floor boards against the 40 feet side of the frames, and pre-assembled square “U”-shape wall units that slide out of both sides of the container frame.

34. The method of claim 30 of building a house with standard container frames, wherein assembling the container comprises:
1) pulling out the ceiling/roof beams embedded in the top sides of the frame;
2) pulling out the floor beams embedded in the bottom sides of the frame;
3) pulling down the floor boards from the sides of the frame to rest on the floor beams;
4) pushing up the ceiling/roof boards from the sides of the container frame against the ceiling/roof beams;
5) placing temporary columns between the ceiling/roof and the floor boards;
6) pulling out the pre-assembled square “U”-shape wall unit recessed in the container frame;
7) connecting the ceiling/roof beams to the floor beams with wires/cables fitted with shackles;
8) tightening the shackles so that the pre-assembled square “U”-shape wall units are sandwiched tightly between the ceiling/roof boards and the floor boards; and
9) running a steel rod between the “U”-shape walls and through the whole length of container house to provide rigidity to the segments of the container house which are drawn out of the main frame of the container house.

35. The cylindrical foundation of claim 32, comprising seamless steel pipes of a predetermined length and thickness, each pipe having:
(A) a steel pole with a twist-lock attachment at a first/top end, and a first set of dampers welded perpendicularly to the pole about three or four meters from the twist-lock attachment with the dampers nearly touching the inside of the steel pipe;
(B) the steel pole having a second set of several dampers welded at a second/bottom end at an angle of about 45 degrees resting on a circular steel ring or rim welded to the bottom end in the inside of the steel pipe and nearly touching the inside of the steel pipe;
(C) a seal at the first/top end with a cover having a rubberized O-ring in the inside of the cover with only the first/top end of the steel pole with the twist-lock attachment protruding out of the cover or, each steel pipe having a rubberized O-ring between the steel pole and the cover, and a rubberized O-ring between the cover and the pipe; and
(D) a seal at the second/bottom end with a lid attached with a hinge to the steel pipe, or with the lid welded to the steel pipe.

36. A method of using a container house for (mass) urban development, the method comprising:
1) constructing a mega structure comprising two identical steel structures facing each other horizontally, with construction techniques developed for large structures to withstand earthquakes and hurricanes;
2) constructing several steel floors for the mega structure having twist-lock arrangements built into the floors to allow for a plurality of the container houses reinforced with wires/cables and shackles for structural support against earthquakes and hurricanes to be secured by twist-locks to the floors;
3) placing cranes on tracks straddling the two steel structures;
4) attaching stairwells containing staircases and elevators for people and machinery to move up and down the steel structures; and
5) building and attaching several identical mega structures to each other and facing each other, the mega structures horizontally connected by tracks, each mega structure having a plurality of steel floors, twist-lock arrangements embedded in the floors, stairwells with staircase and elevators attached to the structures.

37. A method of processing container houses for (mass) urban development, the method comprising:
1) hoisting container houses from tractor-trailers parked on the ground level with a crane to a desired floor in a mega structure for placement of the container houses;
2) off-loading the container houses from the crane with a forklift and transporting each container house to its desired location on the floor for the placement of each container house;
3) laying each container house down on to the twist-lock arrangement in the floor and locking the container with twist-locks to the floor; and
4) assembling each container house by
a) pulling out ceiling/roof beams embedded in the top sides of a frame of each container house,
b) pulling out floor beams embedded in the bottom sides of the frame,
c) pulling down the floor boards from the sides of the frame to rest on the floor beams,
d) pushing up the ceiling/roof boards from the sides of the container frame against the ceiling/roof beams,
e) placing temporary columns between the ceiling/roof and the floor boards,
f) pulling out a pre-assembled square “U”-shape wall unit recessed in the container frame,
g) connecting the ceiling/roof beams to the floor beams with wires/cables fitted with shackles,
h) tightening the shackles so that the pre-assembled square “U”-shape wall units are sandwiched tightly between the ceiling/roof boards and the floor boards, and
i) running a steel rod between the “U”-shape walls and through the whole length of each container house to provide rigidity to the segments of each container house which are drawn out of the main frame of each container house.

38. A method of protecting mega structures against earthquakes and hurricanes with a system of wire meshing draping the mega structure, the method comprising:
for each of a mega structure comprising a larger frame, inserting a smaller frame into each mega structure,
draping wire mesh on the larger frame of the mega structure, the wire mesh further comprising cables,
whereby the smaller frame supports the cables, with the wire mesh being connected to dampers protruding at several places from the larger frame; and
connecting each mega structure to another mega structure, in several places, with the dampers.
